(19) United States
(12) Patent Application Publication
(10) Pub. No.: US 2021/0195521 A1
(43) Pub. Date: Jun. 24, 2021

(54) Wake-Up Monitoring for Discontinuous Reception Mode in a Wireless Communication System

(71) Applicant: Telefonaktiebolaget LM Ericsson (publ), Stockholm (SE)

(72) Inventors: Walter Müller, Upplands Väsby (SE); Björn Hofström, Linköping (SE)

(21) Appl. No.: 16/079,398

(22) PCT Filed: May 4, 2018
(86) PCT No.: PCT/SE2018/050468

§ 371 Date: Aug. 23, 2018

Related U.S. Application Data
(60) Provisional application No. 62/502,131, filed on May 5, 2017.

(51) Int. Cl. H04W 52/02; H04W 76/28; H04W 72/04

(52) U.S. Cl. CPC H04W 52/0219; H04W 72/042; H04W 76/28

(57) ABSTRACT

A user equipment (14) is configured to operate in a connected discontinuous reception, C-DRX, mode. The user equipment (14) is configured to receive a DRX radio network temporary identifier, DRX-RNTI, (22) and/or receive configuration parameters for C-DRX mode that configure the user equipment (14) with a C-DRX cycle including an on-duration period and an off-duration period. The user equipment (14) is configured to operate in a sleep state during the off-duration period. The user equipment (14) is configured to, responsive to receiving a message (26) during a wake-up monitoring period (24), attempt to decode the message (26) using the DRX-RNTI (22). The user equipment (14) is configured to monitor a Physical Downlink Control Channel during the on-duration period of a C-DRX cycle or operate in the sleep state during the on-duration period, depending respectively on whether or not the attempt to decode the message (26) using the DRX-RNTI (22) succeeds.

### TECHNICAL FIELD

The present application relates generally to a wireless communication system, and relates more particularly to operation of a user equipment in a discontinuous reception (DRX) mode.

### BACKGROUND

Communication devices such as User Equipments (UEs) are enabled to communicate wirelessly in a cellular communications network or wireless communication system, sometimes also referred to as a cellular radio system or cellular network. The communication may be performed e.g. between two UEs, between a UE and a regular telephone and/or between a UE and a server via a Radio Access Network (RAN) and possibly one or more core networks, comprised within the cellular communications network.

The communications network covers a geographical area which is divided into cells, wherein each cell is served by one or more transmission points. A cell is a geographical area where radio coverage is provided by one or more transmission points. One or more cells may also have an overlapping cell area. A cell may provide coverage to all UEs in an area adjacent to other cells' coverage areas, whereas a beam only provides coverage to a subset of UEs in a cell, and typically to a subset of the area covered by a cell. Cells may use one radio access technology and beams may use another radio access technology or the same. The non-limiting terms, cells and beams, may be used interchangeably to indicate the coverage provided to a UE.

Long-Term Evolution (LTE) cells transmit a Cell Reference Signal (CRS) in the downlink to allow for synchronization, channel state estimation, identification, and measurements, etc. The cell-specific reference signal is the most basic downlink reference signal, which is transmitted in some standardized subframe(s) and in some standardized Resource Elements (REs) in the frequency domain. Thus, it can cover the entire cell bandwidth. For cell identification, Physical Cell Identity (PCI) is used, which is a limited resource and typically needs to be re-used. For example, in LTE there are 504 different PCIs possible to allocate per frequency layer. In LTE, there are also other reference signals defined. For example, beams also transmit Reference Symbols in the downlink, in this description called Beam Reference Symbols (BRS) for controlling the beam, Channel State Information Reference Symbols (CSI-RS) and Mobility Reference Signals (MRS), for more or less the same purposes as CRS and PCI. To control a beam width and direction, typically several antenna points are arranged in an array and the power, phase, and BRS allocation is controlled for each antenna point.

A typical handover evaluation for coverage-triggered handover in Radio Resource Connection (RRC) Connected mode uses downlink measurements performed on a Cell Reference Signal (CRS) by the UE, identification performed on PCI by the UE, and event-triggered measurement reporting. For example, the radio access scheme for Long Term Evolution (LTE) triggers downlink measurement reporting based on two parameters associated with a reference signal—Reference Signal Received Power (RSRP) and Reference Signal Received Quality (RSRQ). A mobile terminal performs the downlink measurements when the mobile terminal is in RRC Connected mode (with an RRC connection established) and in RRC Idle mode (with no RRC connection established).

A UE may use so-called Discontinuous Reception (DRX) in order to receive information from the network only discontinuously in time, e.g., once per DRX cycle. This helps the UE conserve power and prolong battery life. A UE may use DRX both in RRC Idle mode and RRC Connected mode. The time a UE is available for paging and/or scheduling during a DRX cycle is referred to as UE “on duration”, “active time”, or “active time occasion”, e.g., because the UE activates its receiver during this time. Typically, active time occasions are also used by the UE to perform measurements and report measurements in order to support mobility, such as, handovers. A UE operating in DRX mode may only measure a reference signal, e.g. CRS, and perform identification verification, e.g. by using the related PCI, during a part of the DRX cycle, e.g., just before, after or during the UE's active time.

Even with DRX, there is still a need for improving and extending the battery lifetime of mobile devices. Thus, further reducing the time a device needs to monitor the downlink (DL) and minimizing the overhead transmissions will help the UE save battery and extend the battery lifetime.

### SUMMARY

Some embodiments herein provide increased user equipment power conservation and/or battery life by configuring the user equipment to selectively and/or conditionally operate in the sleep state also during the on-duration period of a C-DRX cycle, e.g., if the user equipment does not need to receive and/or transmit during the on-duration period. That is, rather than always waiting until the off-duration period of a C-DRX cycle to operate in the sleep mode, the user equipment may selectively and/or conditionally operate in the sleep mode earlier, i.e., already in the on-duration period of a C-DRX cycle. For example, the user equipment may be configured to operate in the sleep state during the on-duration period of a C-DRX cycle or to monitor a downlink control channel (e.g., a PDCCH) during that on-duration period, e.g., as directed or otherwise controlled by a radio network node. In some embodiments, for instance, the radio network node effectively signals or indicates to the user equipment whether to monitor the downlink control channel during the on-duration period of a C-DRX cycle or to operate in the sleep state during the on-duration period, e.g., by, during a wake-up monitoring period, transmitting or not transmitting a message based on an identifier (e.g., DRX-RNTI) assigned to the user equipment.

More particularly, embodiments herein include a method performed by a radio network node for controlling DRX active time of a user equipment operating in a connected discontinuous reception, C-DRX, mode within which the user equipment has a radio resource control, RRC, connection. The method may comprise transmitting a DRX radio network temporary identifier (DRX-RNTI) to the user equipment. They method may alternatively or additionally comprise transmitting to the user equipment configuration parameters for C-DRX mode that configure the user equipment with a C-DRX cycle including an on-duration period and an off-duration period. The user equipment is to operate in a sleep state during the off-duration period. The method also comprises indicating to the user equipment whether to monitor a control channel (e.g., a Physical Downlink Control Channel, PDCCH) during the on-duration period of a C-DRX cycle or to operate in the sleep state during the on-duration period, by respectively transmitting or not transmitting a message based on the DRX-RNTI during a wake-up monitoring period.

In some embodiments, the DRX-RNTI is assigned to a group of user equipments that includes the user equipment. In one embodiment, for example, the user equipments in the group are assigned the same C-DRX phase within the C-DRX cycle, wherein the C-DRX phase is the on-duration period of the C-DRX cycle. Alternatively or additionally, the user equipments in the group may be associated with the same active or monitored set of beams. In either case, the radio network node in some embodiments indicates to the user equipments in the group, including the user equipment, whether to monitor a PDCCH during the on-duration period of a C-DRX cycle or to operate in the sleep state during the on-duration period, by respectively transmitting or not transmitting a message based on the DRX-RNTI during a wake-up monitoring period. In any of these embodiments, the message may specify which user equipments in the group are to monitor a PDCCH during the on-duration period of the C-DRX cycle.

Regardless of whether the DRX-RNTI is assigned to a group of user equipments, in some embodiments, the method further comprises, during the wake-up monitoring period, transmitting control messages only in a common search space that is common to multiple user equipments.

In some embodiments, the configuration parameters specify when the wake-up monitoring period occurs. Alternatively or additionally, the configuration parameters in some embodiments specify whether or not the user equipment is to prepare to transmit in the on-duration period of a C-DRX cycle, and/or whether or not the user equipment is to prepare to transmit in the wake-up monitoring period of a C-DRX cycle.

In some embodiments, the wake-up monitoring period starts at the beginning of a C-DRX cycle with which the user equipment is configured. Alternatively or additionally, the wake-up monitoring period in some embodiments is shorter than the on-duration period of a C-DRX cycle.

In some embodiments, the indicating in the method comprises indicating to the user equipment whether to monitor a PDCCH during the on-duration period of a next C-DRX cycle occurring after the C-DRX cycle within which is transmitted a message during a wake-up monitoring period, or operating in the sleep state during the on-duration period of the next C-DRX cycle, by respectively transmitting or not transmitting a message based on the DRX-RNTI during the wake-up monitoring period.

In any of these embodiments, the message may be a downlink control information (DCI) message transmitted on a PDCCH, and the a cyclic redundancy code (CRC) included in the message may be calculated using the DRX-RNTI.

Embodiments herein also include a method performed by a user equipment for operating in a connected discontinuous reception, C-DRX, mode within which the user equipment has a radio resource control, RRC, connection. The method may comprise receiving a DRX radio network temporary identifier, DRX-RNTI, from a radio network node. Alternatively or additionally, the method may comprise receiving from the radio network node configuration parameters for C-DRX mode that configure the user equipment with a C-DRX cycle including an on-duration period and an off-duration period. The user equipment is configured to operate in a sleep state during the off-duration period. The method in some embodiments also comprises, responsive to receiving a message from the radio network node during a wake-up monitoring period, attempting to decode the received message using the DRX-RNTI. The method further includes monitoring a Physical Downlink Control Channel, PDCCH, during the on-duration period of a C-DRX cycle or operating in the sleep state during the on-duration period, depending respectively on whether or not the attempt to decode the received message using the DRX-RNTI succeeds.

In some embodiments, the DRX-RNTI is assigned to a group of user equipments that includes the user equipment. In one embodiment, for example, the user equipments in the group are assigned the same C-DRX phase within the C-DRX cycle, wherein the C-DRX phase is the on-duration period of the C-DRX cycle. Alternatively or additionally, the user equipments in the group are associated with the same active or monitored set of beams. In either case, the received message in some embodiments specifies which user equipments in the group are to monitor a PDCCH during the on-duration period of the C-DRX cycle.

In some embodiments, the method further comprises, during the wake-up monitoring period, only monitoring a common search space that is common to multiple user equipments.

In some embodiments, the configuration parameters specify when the wake-up monitoring period occurs. Alternatively or additionally, the configuration parameters in some embodiments specify whether or not the user equipment is to prepare to transmit in the on-duration period of a C-DRX cycle, and/or whether or not the user equipment is to prepare to transmit in the wake-up monitoring period.

In some embodiments, the wake-up monitoring period starts at the beginning of a C-DRX cycle with which the user equipment is configured. Alternatively or additionally, the wake-up monitoring period in some embodiments is shorter than, the on-duration period of a C-DRX cycle.

In some embodiments, the monitoring or operating in the method comprises monitoring a PDCCH during the on-duration period of a next C-DRX cycle occurring after the C-DRX cycle within which was received a message during a wake-up monitoring period, or operating in the sleep state during the on-duration period of the next C-DRX cycle, depending respectively on whether or not the attempt to decode the received message using the DRX-RNTI succeeds.

In any of these embodiments, the message may be a downlink control information (DCI) message received on a PDCCH, and attempting to decode the message may comprise using the DRX-RNTI to check a cyclic redundancy code (CRC) included in the DCI message.

Embodiments herein also include corresponding apparatus, computer programs, and carriers (e.g., non-transitory computer-readable mediums). For example, embodiments herein include a radio network node for controlling DRX active time of a user equipment operating in a connected discontinuous reception, C-DRX, mode within which the user equipment has a radio resource control, RRC, connection. The radio network node may be configured (e.g., via radio circuitry and/or processing circuitry) to perform any of the aspects of the method described above. For instance, the radio network node may be configured to transmit a DRX radio network temporary identifier (DRX-RNTI) to the user equipment, and/or to transmit to the user equipment configuration parameters for C-DRX mode that configure the user equipment with a C-DRX cycle including an on-duration period and an off-duration period. The user equipment is to operate in a sleep state during the off-duration period. The radio network node is configured to indicate to the user equipment whether to monitor a control channel (e.g., a Physical Downlink Control Channel, PDCCH) during the on-duration period of a C-DRX cycle or to operate in the sleep state during the on-duration period, by respectively transmitting or not transmitting a message based on the DRX-RNTI during a wake-up monitoring period.

Embodiments herein also include a user equipment configured to operate in a connected discontinuous reception, C-DRX, mode within which the user equipment has a radio resource control, RRC, connection. The user equipment may be configured (e.g., via radio circuitry and/or processing circuitry) to perform any of the aspects of the method described above. For instance, the user equipment may be configured to receive a DRX radio network temporary identifier, DRX-RNTI, from a radio network node, and/or to receive from the radio network node configuration parameters for C-DRX mode that configure the user equipment with a C-DRX cycle including an on-duration period and an off-duration period. The user equipment is configured to operate in a sleep state during the off-duration period. The user equipment in some embodiments is also configured to, responsive to receiving a message from the radio network node during a wake-up monitoring period, attempt to decode the received message using the DRX-RNTI. The user equipment is further configured to monitor a Physical Downlink Control Channel, PDCCH, during the on-duration period of a C-DRX cycle or operate in the sleep state during the on-duration period, depending respectively on whether or not the attempt to decode the received message using the DRX-RNTI succeeds.

### BRIEF DESCRIPTION OF THE DRAWINGS

FIG. 1 is a block diagram of a wireless communication network that includes a radio network node and a user equipment according to some embodiments.

FIG. 2 is a block diagram of a C-DRX cycle according to some embodiments.

FIG. 3 is a block diagram of a C-DRX cycle and a wake-up monitoring period according to some embodiments.

FIG. 4 is a block diagram of a wireless communication network according to some embodiments.

FIG. 5 is a block diagram of a wireless communication network that groups user equipments according to some embodiments.

FIG. 6 is a logic flow diagram of a method performed by a radio access node to group user equipments according to some embodiments.

FIG. 7 is a block diagram of a network device according to some embodiments.

FIG. 8 is a logic flow diagram of a method performed by a user equipment according to some embodiments.

FIG. 9 is a logic flow diagram of a method performed by a radio network node according to some embodiments.

FIG. 10 is a block diagram of a user equipment according to some embodiments.

FIG. 11 is a block diagram of a user equipment according to other embodiments.

FIG. 12 is a block diagram of a radio network node according to some embodiments.

FIG. 13 is a block diagram of a radio network node according to other embodiments.

FIG. 14 is a block diagram of a wireless communication network according to some embodiments.

FIG. 15 is a block diagram of a user equipment according to some embodiments.

FIG. 16 is a block diagram of a virtualization environment according to some embodiments.

FIG. 17 is a block diagram of a communication network with a host computer according to some embodiments.

FIG. 18 is a block diagram of a host computer according to some embodiments.

### DETAILED DESCRIPTION

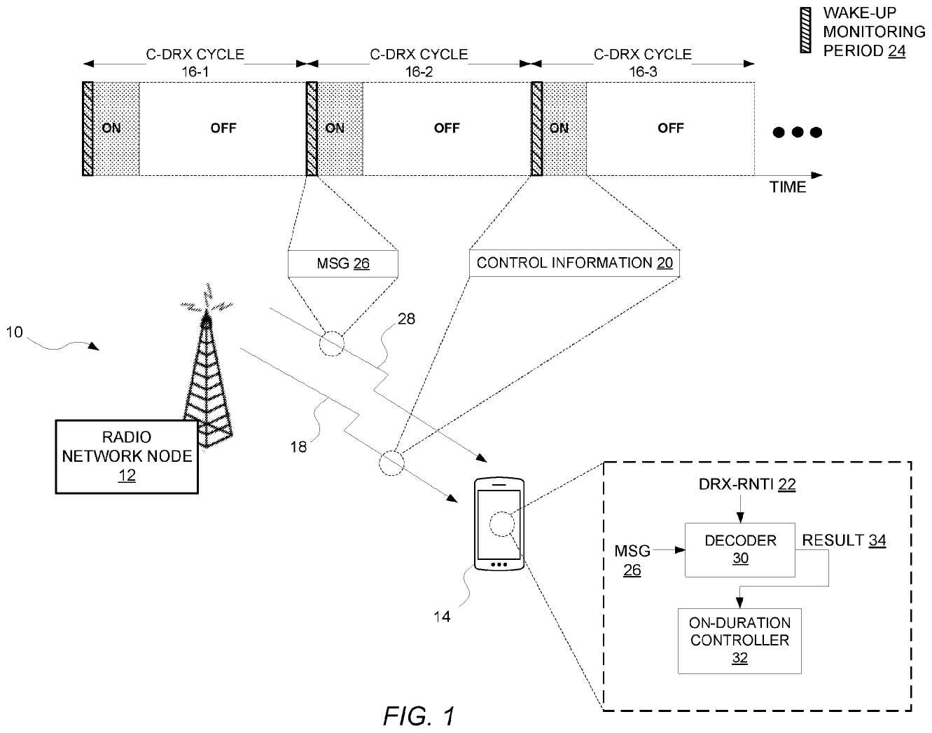

FIG. 1 shows a wireless communication network 10 according to some embodiments. The network 10 includes a radio network node 12 (e.g., a base station) in a radio access network portion of the network 10. The network 10 as shown also includes a user equipment (UE) 14 configured to wirelessly communicate with the radio network node 12, e.g., for connecting to a core network portion (not shown) of the network 10.

The user equipment 14 is configured, e.g., after a period of inactivity, to operate in a discontinuous reception (DRX) mode during which the user equipment 14 receives information from the radio network node 12 only discontinuously in time. In some embodiments, the user equipment 14 is configured to operate in DRX mode when the user equipment 14 has a radio resource control (RRC) connection with the network 10 (i.e., in RRC Connected state), in which case the user equipment 14 operates in a so-called connected DRX (C-DRX) mode. Alternatively or additionally, the user equipment 14 is configured to operate in DRX mode when the user equipment 14 has no RRC connection with the network 10 (i.e., in RRC Idle state). In some embodiments, for example, a user equipment with an RRC connection may operate in C-DRX mode after a period of inactivity and then transition to using DRX in RRC Idle state if the user equipment's inactivity continues for a certain amount of time.

FIG. 1 as an example shows the user equipment 14 as being configured to operate in C-DRX mode. The user equipment 14 in this regard is configured with a C-DRX cycle 16, e.g., that periodically recurs over time as C-DRX cycle 16-1, C-DRX cycle 16-2, C-DRX cycle 16-3, and so on so as to be cyclic. A C-DRX cycle includes an on-duration period (“ON” in FIG. 1) and an off-duration period (“OFF” in FIG. 1). The user equipment 14 in some embodiments is configured with such a C-DRX cycle 16 by or based on one or more configuration parameters received from the radio network node 12, e.g., specifying the starting time and/or periodicity of the C-DRX cycle 16, specifying the length of the on-duration period and/or the length of the off-duration period, or the like.

Regardless, the user equipment 14 is configured to operate in a sleep state during the off-duration period of a C-DRX cycle, e.g., by turning off at least some user equipment circuitry such as by turning off one or more receivers. While operating in the sleep state during the off-duration period, the user equipment 14 is relieved from having to monitor a downlink control channel 18 (e.g., a Physical Downlink Control Channel, PDCCH) for downlink control information (DCI) 20. This may conserve power and/or prolong battery life of the user equipment 14.

Some embodiments herein enable even greater power conservation and/or battery life by configuring the user equipment 14 to selectively and/or conditionally operate in the sleep state also during the on-duration period of a C-DRX cycle 16, e.g., if the user equipment 14 does not need to receive and/or transmit during the on-duration period. That is, rather than always waiting until the off-duration period of a C-DRX cycle to operate in the sleep mode, the user equipment 14 may selectively and/or conditionally operate in the sleep mode earlier, i.e., already in the on-duration period of a C-DRX cycle 16. For example, the user equipment 14 may be configured to operate in the sleep state during the on-duration period of a C-DRX cycle 16 or to monitor a downlink control channel 18 (e.g., a PDCCH) during that on-duration period, e.g., as directed or otherwise controlled by the radio network node 12. In some embodiments, for instance, the radio network node 12 effectively signals or indicates to the user equipment 14 whether to monitor the downlink control channel 18 during the on-duration period of a C-DRX cycle 16 or to operate in the sleep state during the on-duration period, e.g., based on whether the radio network node 12 will send control information 20 to the user equipment 14 on the downlink control channel 18 during the on-duration period.

In this regard, the user equipment 14 according to some embodiments is configured with a so-called DRX radio network temporary identifier (RNTI), DRX-RNTI 22, also referred to herein as a C-DRX-RNTI as specifically applicable to C-DRX mode. The user equipment 14 may for example receive the DRX-RNTI 22 from the radio network node 12. The user equipment 14 is also configured with a so-called wake-up monitoring period 24. The user equipment 14 may for example receive from the radio network node 12 one or more configuration parameters that specify when the wake-up monitoring period 24 occurs. FIG. 1 for instance shows that the wake-up monitoring period 24 starts at the beginning of each C-DRX cycle 16-1, 16-2, 16-3, etc. so as to be included in and/or overlap with a portion of the on-duration of each C-DRX cycle. FIG. 1 also shows the wake-up monitoring period 24 as being shorter in time than the on-duration period of a C-DRX cycle 16. Although FIG. 1 shows that the wake-up monitoring period 24 in some embodiments starts at the beginning of each C-DRX cycle 16, the wake-up monitoring period 24 in other embodiments may occur at the end of each C-DRX cycle, e.g., so as to end at the beginning of each C-DRX cycle.

Regardless, the radio network node 12 is configured to indicate to the user equipment 14 whether to monitor the downlink control channel 18 (e.g., PDCCH) during an on-duration period of a C-DRX cycle 16 or to operate in the sleep state during that on-duration period, by respectively transmitting or not transmitting a message 26 based on the DRX-RNTI 22 during a wake-up monitoring period 24. That is, the radio network node 12 may indicate to the user equipment 14 to monitor the downlink control channel 18 during the on-duration period by transmitting a message 26 based on the DRX-RNTI 22 during the wake-up monitoring period 24. As shown in FIG. 1, for example, the radio network node 12 may be configured to transmit the message 26 based on the DRX-RNTI 22 during the wake-up monitoring period 24 that starts at the beginning of C-DRX cycle 16-2, in order to indicate to the user equipment 14 to monitor the downlink control channel 18 during the on-duration period of the next C-DRX cycle 16-3, i.e., the next C-DRX cycle occurring after the C-DRX cycle within which (or for which) the message 26 was transmitted/received during the wake-up monitoring period 24. Or, the radio network node 12 may instead indicate to the user equipment 14 to operate in the sleep state during the on-duration period, by not transmitting the message 26 based on the DRX-RNTI 22 during the wake-up monitoring period 24, e.g., by either not transmitting any message 26 during the wake-up monitoring period or by transmitting a message 26 during the wake-up monitoring period but not based on the DRX-RNTI 22. The radio network node 12 may transmit the message 26 on a channel 28 that is the same or different than the control channel 18 over which control information 20 is to be sent.

In any event, responsive to receiving a message 26 from the radio network node 12 during a wake-up monitoring period 24, the user equipment 14 is configured to attempt to decode the received message 26 using the DRX-RNTI 22; namely, the DRX-RNTI 22 assigned to the user equipment 14. If the attempt to decode the received message 26 using the DRX-RNTI 22 succeeds, the user equipment 14 monitors the control channel 18 during the on-duration period of the C-DRX cycle 16. Otherwise, if the attempt to decode the received message 26 using the DRX-RNTI 22 does not succeed (or if no message is received during the wake-up monitoring period 24), the user equipment 14 operates in the sleep state during that on-duration period. FIG. 1 in this regard shows that the user equipment 14 may have a decoder 30 that attempts to decode any message 26 received during the wake-up monitoring period 24 using the DRX-RNTI 22. FIG. 1 shows that the user equipment 14 also has an on-duration controller 32 that controls the user equipment 14 to monitor the control channel 28 during the on-duration period or to operate in the sleep state during the on-duration period, depending on a result 34 of the decoding (i.e., whether the decoding attempt succeeds or fails).

In some embodiments, for example, the message 26 is a downlink control information (DCI) message transmitted on the downlink control channel 18 (e.g., PDCCH). In these and other cases, then, the radio network node 12 may transmit the message 26 based on the DRX-RNTI 22 such that a cyclic redundancy check (CRC) included in the message 26 is calculated using the DRX-RNTI 22. The user equipment 14 correspondingly monitors the downlink control channel 18 to see if any DCI message has a CRC attached with the DRX-RNTI 22 included in the calculation. If such a CRC checks, the user equipment 14 considers receipt of the message a wake-up call and starts monitoring the downlink control channel 18 during the on-duration period.

Especially in embodiments where the message 26 is transmitted/received during the wake-up monitoring period 24 on the same (or same type of) downlink control channel 18 as that on which the downlink control channel 18 is to be received during the on-duration period, some embodiments advantageously allow the user equipment 14 to receive the message 26 during the wake-up monitoring period 24 using the same receiver, or same type of receiver, with which the user equipment 14 receives the control information message during the on-duration. Indeed, in some embodiments, the user equipment 14 monitors the downlink control channel 18 for a downlink control information message in the same way as it monitors the channel 28 for message 26, but just attempts to decode the messages using different RNTIs. In these embodiments, then, wake-up is accomplished without the extra need and complexity of a special “wake-up” receiver. Of course, although embodiments herein are capable of being used without a special “wake-up” receiver, the embodiments are not so limited, e.g., a special “wake-up” receiver can be used if otherwise desired. Alternatively or additionally, particularly in embodiments where the wake-up monitoring period 24 is shorter than the on-duration period of a C-DRX cycle, some embodiments advantageously enable the user equipment 14 to monitor the downlink for a shorter amount of time and correspondingly operate in the sleep state for a longer amount of time. This in turn reduces the user equipment's power consumption and increases the user equipment's battery life.

Moreover, some embodiments limit the extent to which the user equipment 14 must search (e.g., using blind decoding) to determine whether any message 26 based on the DRX-RNTI 22 has been transmitted within the wake-up monitoring period 24. Limiting the user equipment's search in this way may further reduce the time and complexity needed for the user equipment 14 to detect the message 26 during the wake-up monitoring period 24. This may in turn further reduce the user equipment's power consumption and increase the user equipment's battery life.

More particularly, in some embodiments, the user equipment 14 is assigned a user-specific search space within which to search for control messages/channels (e.g., PDCCH) intended for the user equipment. A common search space is also defined within which multiple user equipments commonly search for control messages/channels (e.g., PDCCH”) intended for them. In some embodiments, a search space is a set of candidate control channels (e.g., candidate PDCCHs) formed by control channel elements (CCEs) on a given aggregation level, which the user equipment 14 may attempt to decode. Regardless, according to some embodiments, during the wake-up monitoring period 24, the user equipment 14 is configured to only monitor the common search space (e.g., of the PDCCH) that is common to multiple user equipments. The radio network node 12 is correspondingly configured to, during the wake-up monitoring period 24, transmit the message 26 (or any control messages) only in the common search space (e.g., of the PDCCH). This means that the user equipment 14 need not search the user-specific search space, thereby avoiding the time, complexity, and power that would have otherwise been required for the user equipment 14 to blindly decode that user-specific search space.

Alternatively or additionally, some embodiments dedicate the wake-up monitoring period 24 for downlink transmission (e.g., of message 26) to the user equipment 14, meaning that no uplink transmission by the user equipment 14 is permitted or required. Limiting the wake-up monitoring period 24 to downlink transmission allows the user equipment 14 to selectively activate its receiving circuitry during the wake-up monitoring period 24, while keeping its transmission circuitry in a sleep state. This may further save power consumption and increase battery lifetime at the user equipment 14.

In one or more embodiments, though, uplink transmission by the user equipment 14 during the wake-up monitoring period 24 is configurable, e.g., via signalling from the radio network node 12. For example, in some embodiments, the radio network node 12 transmits configuration parameters to the user equipment 14 specifying whether or not the user equipment 14 is to prepare to transmit in the wake-up monitoring period 24. In other embodiments, if the user equipment 14 is to prepare to transmit in the wake-up monitoring period 24, the radio network node 12 transmits specific signalling indicating such to the user equipment 14, but if the user equipment 14 need not prepare to transmit in the wake-up monitoring period 24, the radio network node 12 refrains from transmitting that signalling (e.g., so as to implicitly signal that the user equipment 14 need not prepare to transmit in the wake-up monitoring period 24). The user equipment 14 in this case is configured not to prepare to transmit in the wake-up monitoring period 24 without this specific signalling from the radio network node 12.

Some embodiments may extend these and other aspects to the on-duration period of a C-DRX cycle. That is, in some embodiments, uplink transmission by the user equipment 14 during the on-duration period is configurable, e.g., via signalling from the radio network node 12 similarly as described above with respect to the wake-up monitoring period 24.

Although FIG. 1 illustrates embodiments herein with respect to a single user equipment 14, embodiments herein extend to multiple user equipments. In some embodiments, for example, different user equipments are assigned different respective DRX-RNTIs. In this case, each user equipment may monitor a PDCCH during the on-duration period of a C-DRX cycle or operate in the sleep state during that on-duration period, depending respectively on whether or not the user equipment succeeds in decoding any message received during a wake-up monitoring period 24 using the user equipment's assigned DRX-RNTI. These and other embodiments may thereby “wake up” user equipments selectively, e.g., only those to which the radio network node 12 will send control information 20 in the on-duration period.

In other embodiments, the same DRX-RNTI may be assigned to a group of user equipments, including the user equipment 14 shown in FIG. 1. In this case, then, the radio network node 12 may wake up the group of user equipments (e.g., at the same time) by transmitting a single message 26 based on the same DRX-RNTI during a wake-up monitoring period 24. This may advantageously consume less radio resources than transmitting different messages based on different DRX-RNTIs assigned to different user equipments.

In some embodiments, the same DRX-RNTI may be assigned to a group of user equipments, but the message 26 transmitted during the wake-up monitoring period 24 may include information specifying which user equipments in the group are to wake up during the on-duration period, e.g., for monitoring the PDCCH during the on-duration period. In this case, all user equipments in the group will succeed at decoding the message 26 using the same DRX-RNTI, but the message 26 includes information indicating which of those user equipments are to monitor the PDCCH during the on-duration period and which of those user equipments are to instead operate in the sleep state during the on-duration period. For example, the message 26 may have a certain DCI format which includes this information. The message 26 in some embodiments may alternatively or additionally indicate where and when user equipments may find the control information 20, e.g., a grant.

Regardless of whether the message 26 includes information specifying which user equipments in the group are to wake up, the user equipments may be so grouped based on any sort of criteria or needs of the user equipments. As exemplified more fully below, for instance, the user equipments in the group may be associated with the same active or monitored set of beams. Alternatively or additionally, the user equipments in the group may be assigned the same C-DRX phase within a C-DRX cycle. The C-DRX phase here may be the on-duration period of the C-DRX cycle, i.e., the user equipments have the same on-duration period. In this regard, the configuration of DRX schemes in the radio access network may make sure that the active time occasion for a number of user equipments are spread out in time, even if the user equipments are using the same DRX cycle, so that not all user equipments wake up at the same time instance. The absolute time instance a certain UE or a group of UEs wakes up is called DRX phase.

These and other embodiments will now be described more fully, at times in the context of certain wireless communication standards or protocols (e.g., LTE or 5G).

Transmissions to UEs may be provided according to resources defined for a cell, sector, antenna beam or beam set, or resources that may be defined for providing coverage to any area of a cell. A beam may not cover all UEs in a cell; however, beams may be used to extend coverage for selected UEs. To support high speed UEs with as little UE-to-network signaling as possible, schemes where cells/beams follow the UE may be provided, rather than requiring the UE to change cell/beam via handover.

A goal of 5G systems is “lean carrier” radio access. “Lean carrier” implies that cells or beams do not transmit anything unless there is a communication session with one or more UEs. Lean Carrier reduces, or makes lean, the level of reference signaling needed for proper network performance, which leads to a corresponding improvement of the downlink data speed that applies to all parts of the 5G network, with the highest performance gains occurring in the areas with the most cell overlap. It is noted that in Wideband Code Division Multiple Access (WCDMA), there are events already defined to support maintenance of an active set of cells that allow a UE to only send measurements reports when the UE's active set needs to be changed.

Existing solutions for cell/beam based mobility are handled on a per UE basis which may not be an efficient use of resources and power.

Active UEs in RRC connected mode must monitor the downlink (e.g., a physical downlink control channel, PDCCH) for Downlink Control Information, DCI, to see if there is a downlink assignment or uplink grant to which they should respond. To prevent active UEs in RRC connected mode from having to monitor for DCI continuously, a power saving feature in connected mode is used for LTE and is called connected mode DRX, C-DRX. This power saving feature enables the UE to enter C-DRX after a time of inactivity in which the UE only wakes up to monitor the PDCCH according to a configured On-Duration time per C-DRX Cycle.

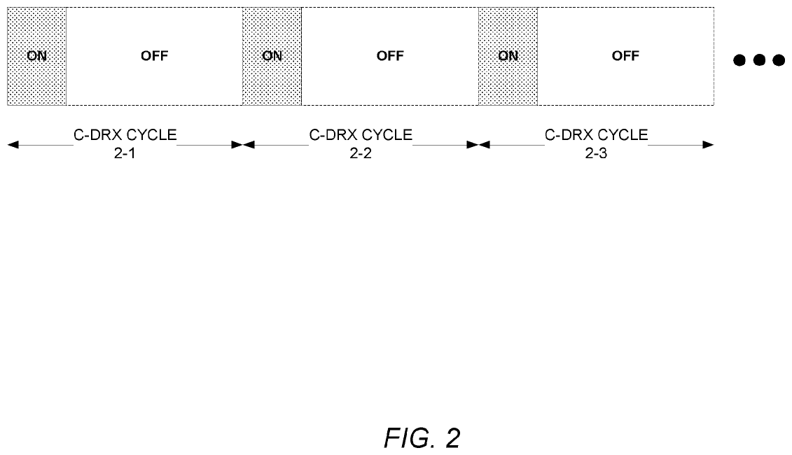

FIG. 2 shows one example of C-DRX cycles, e.g., in an Evolved Universal Mobile Telecommunications Systems (UMTS) Terrestrial Radio Access network (E-UTRAN). In particular, FIG. 2 shows C-DRX cycles that recur periodically (i.e., cyclically) as cycle 2-1, cycle 2-2, cycle 2-3, etc. Each cycle has a respective On-duration followed by an Off-duration. The UE wakes up to monitor the PDCCH during each On-Duration, but goes to sleep during each Off-duration.

Since LTE is agreed to be used as a baseline for New Radio (NR), C-DRX will also be used as a power saving feature in NR.

When transmitting a DCI message to a UE, a cyclic redundancy check (CRC) is attached to each DCI message payload. The identity of the device or devices, i.e. the Radio Network Temporary identifier, RNTI, is included in the CRC calculation and not explicitly transmitted. Depending on the purpose of the DCI, different RNTIs are used. When the UE monitors and tries to decode the PDCCH, the UE will check the CRC using a set of assigned RNTIs. If the CRC checks, the message is declared to be correctly received and intended for the UE. Thus, the identity of the device that the message is intended for is implicitly encoded in the CRC and not explicitly transmitted.

When the UE wakes up once every C-DRX cycle, it needs to monitor the PDCCH during the On-Duration period. A typical setting for LTE C-DRX On-Duration is observed to be in the order of tens of milliseconds and thus, the UE must heretofore stay awake for the entire On-Duration even if there is no data scheduled for the UE. This could be viewed as a power waste for the UE.

The power consumption is further increased by the fact that the UE is required to be able to receive data during and immediately following the On-Duration. The UE is expected to decode the data received during On-Duration and provide hybrid automatic repeat request (HARQ) feedback a few milliseconds after reception. In order to perform the delay sensitive processing in C-DRX the UE needs to have more processing hardware (HW) activated which consumes more power.

According to some approaches, a short “wake up” indication may be used to allow an eNB to indicate to a UE when the eNB wants the UE to start monitoring the PDCCH continuously. This may allow the UE, if so implicitly indicated, to go back to sleep mode early and not monitor PDCCH until the next period of time configured by the network. Some of these approaches involve the use of a specific wake up receiver and it remains to be seen if any power savings can be made but it would increase the complexity of the receiver due to the need of an extra energy-efficient receiver.

A “wake-up” indication seems to be an energy-efficient way to allow the UE to stop monitoring PDCCH and go back to sleep mode when the network has no indication of any downlink or uplink data. But the wake-up should preferable be done without the extra need and complexity of a “wake-up” receiver.

Some embodiments herein make use of a specific identifier to allow for the network to indicate whether a UE should monitor the PDCCH for a period of time. According to some embodiments, this specific identifier provides an energy efficient, low complexity “wake up” indication for the UE that decreases the power consumption of the UE in connected mode DRX.

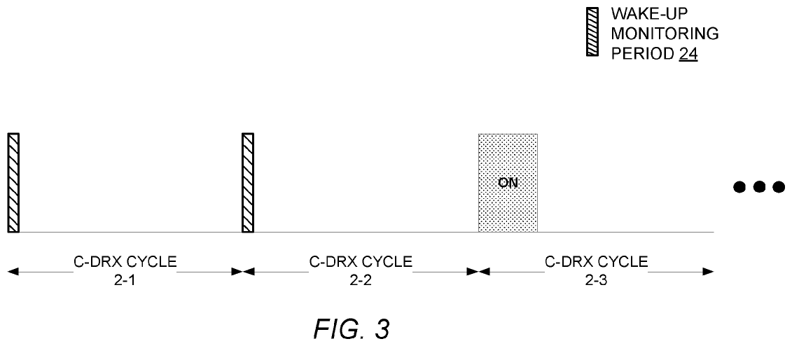

In one embodiment, the network will assign a “DRX” RNTI to a UE configured for C-DRX operation. The UE then monitors PDCCH to see if any DCI has a CRC attached with the assigned DRX-RNTI included in the calculation. When the UE monitors and tries to decode the PDCCH, the UE will check the CRC using the assigned DRX-RNTI. If the CRC checks, the message is declared to be correctly received and intended for the UE and it should be regarded as a wake-up call and the UE would know that it should start monitoring PDCCH according to at a predefined time and at a predefined duration. FIG. 3 shows one example in which the wake-up monitoring period 24 occurs at the beginning of each C-DRX cycle. When the CRC checks for a message received in the wake-up monitoring period of C-DRX cycle 2-2, the UE starts monitoring the PDCCH during the on-duration period of C-DRX cycle 2-3.

In one embodiment a set of DRX-RNTIs is used by the network where each UE is assigned one of the RNTIs. This allows for not “waking up” all UEs monitoring this specific subframe.

According to some embodiments, then, UEs configured for C-DRX are assigned a set of “C-DRX” RNTIs. A shorter on-Duration, a Wake-up indication, is allowed for each UE in C-DRX when the UE monitors the PDCCH to see if any DCI has a CRC attached with the assigned C-DRX RNTI included in the calculation. When the UE monitors and tries to decode the PDCCH, the UE will check the CRC using the assigned C-DRX RNTIs. If the CRC checks, the message is declared to be correctly received and intended for the UE and the UE knows that it should start monitoring the PDCCH according to a longer on-Duration time, at a configured time.

A set of DRX-RNTIs may also be assigned to the UE to indicate how long the UE should wait before starting to monitor the PDCCH. This may minimize the delay imposed by using the wake-up procedure and allowing the UE not to wait until the next On-Duration period.

According to some embodiments, UEs configured with such C-DRX RNTI are provided by the network, through a radio network node, with further specific C-DRX configuration parameters, for instance specifying when and how to monitor the PDCCH when the CRC check is successful, as well as how and when the UE should wake up to try to decode the CRC using the C-DRX RNTI. For instance, one such parameter could indicate if the UE must be prepared to transmit in the On-duration period or at the Wake-up indication period or not. In other embodiments, the UE knows that it need not transmit in the wake-up indication without any specific signalling from the network.

It should be noted that the UE need not activate any transmission circuitry, but only receiving circuitry, to be able to decode the PDCCH in some embodiments since the UE knows that it is not required to do any transmission during this reduced On-duration. This is different from other solutions in which the UE may be required to send for instance HARQ ACK/NACK messages and thus must have both receiving and transmitting circuitry activated. Since the UE may refrain from activating transmission circuitry, further energy may be saved resulting in increased battery time.

Alternatively or additionally, some embodiments allow the UE to only decode the common search space of the PDCCH, saving time and complexity by not having to blindly decode the UE specific search space.

The use of a specific C-DRX RNTI makes it possible to assign the same C-DRX RNTI to a group of UEs. This group can be larger or smaller, but is independent of the available PDCCH space used in other DRX solutions for addressing UEs. It is thus possible to wake-up a large group of UEs, larger than would be possible in other C-DRX solutions, with lesser radio resources by using a single CRC message encoded using a specific C-DRX RNTI.

In an alternative embodiment, the DCI which the CRC is connected to may carry further information specifying specific UEs in the group defined by the C-DRX RNTI, also referred to herein as DRX RNTI.

Some embodiments use a new DCI format, giving more information on what UEs this wake-up concerns, where and when to find the actual grant etc. That is, the assigned DRX-RNTI could be used with a new DCI format allowing only those affected to start monitoring the PDCCH for a grant.

Some embodiments allow the network to indicate to several UEs to wake up at the same time. This could be very useful in a beam-formed 5G system where grouping of UEs in C-DRX could be necessary.

More particularly in this regard, it would be advantageous for a radio access node to transmit to UEs as a group, particularly when the UEs are associated with the same beam set, in order to support “lean carrier” transmission from a radio access node. UE grouping refers to grouping UEs associated with a same cell/beam set. For example, a radio access node that transmits in Discontinuous Transmission (DTX) on a cell/beam would more efficiently use its resources if its transmissions on the cell/beam were coordinated with a group of UEs communicating with the same cell/beams, rather than on a per UE basis. Further, existing solutions for cell/beam-based mobility do not provide a way to coordinate cell/beam DTX transmissions with UE measurement reporting, UE DRX phase, UE active time length, and UE grouping in order to allow high performance mobility and allow for narrow beams and lean carrier usage.

It would be advantageous for a radio access node to group UEs associated with a same beam set in such a manner that the time a particular beam and/or beam set needs to transmit is minimized. It would be further advantageous to allocate the same DRX phase and UE measurement periods for the UEs in each group in such a manner that the time a UE needs to be available for paging and/or scheduling, and for performing measurements is also minimized. In an embodiment of the present disclosure, UEs using the same set of cells/beams may be grouped together in one or more groups and the UEs within each group are assigned to use the same DRX phase within the group.

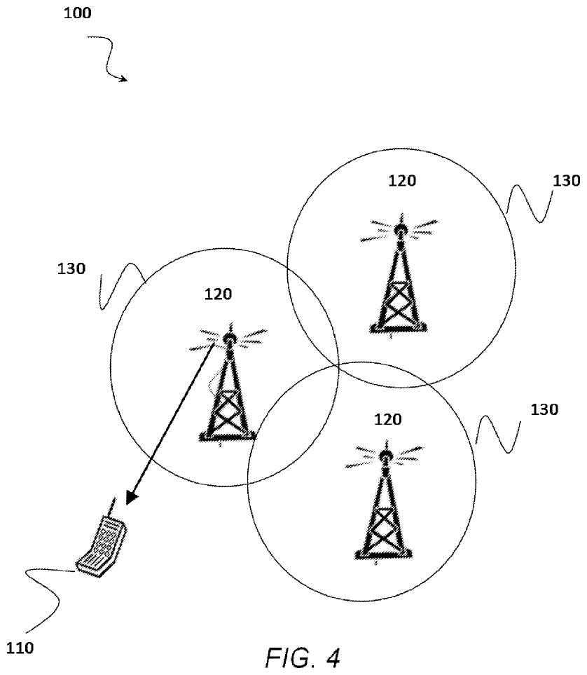

An exemplary wireless communication network 100 is provided in FIG. 4. The wireless communications network 100 includes one or more wireless communication devices 110, one or more radio access nodes 120, and/or other suitable nodes (not shown). Radio access node 120 communicates with wireless device 110 over a wireless interface. For example, radio access node 120 transmits wireless signals to and/or receives wireless signals from wireless communication device 110. The wireless signals contain voice traffic, data traffic, control signals, and reference signals, for example. Radio access node 120 may provide coverage to wireless device 110 in a particular geographical area 130, e.g., a cell, sector, or antenna beam, which non-limiting terms may be used interchangeably or in combination throughout this disclosure.

It should also be appreciated that the non-limiting term radio access node is used herein and can refer to any radio network node or network node that provides access to and controls a UE such as the following (for example): a Node B, an access point (AP), an eNode B, a low power node, a femto node, a pico node, a RNC, a network controller, a central controlling node etc. Finally, it should be appreciated that the non-limiting term user equipment (UE) is used herein and refers to any type of wireless communication device 110 that communicates with radio access node in a wireless communication system such as the following (for example): a target device, a device-to-device (D2D) UE, a machine type UE, a UE capable of machine to machine (M2M) communication, a PDA, an iPad, a tablet, a mobile terminal, a smart phone, a laptop embedded equipment (LEE), a laptop mounted equipment (LME), a USB dongle etc.

Certain embodiments of the present disclosure provide solutions for identifying UEs associated with a same beam set, and grouping the UEs.

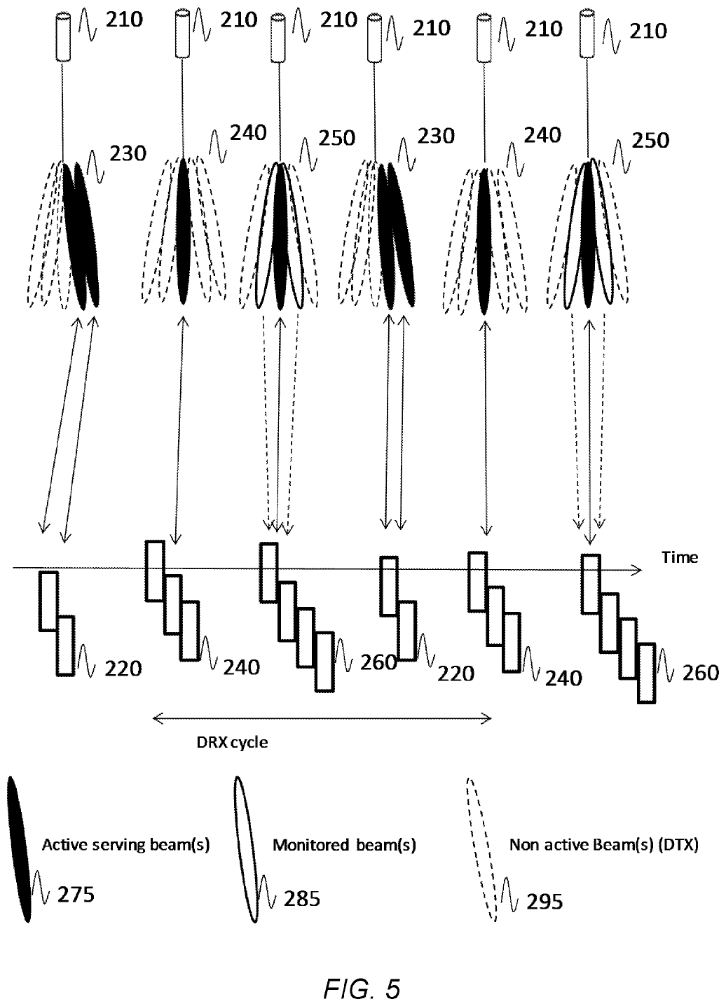

FIG. 5 provides an exemplary grouping of UEs which are associated with particular beam set. In an embodiment, radio access node 210 is communicatively coupled to one or more UEs, 220, 240, 260. In an embodiment, radio access node 210 communicates with one or more UEs 220, 240, 260, respectively, over one or more antenna beams. In various embodiments, antenna beams may be active serving beams 275, monitored beams 285, and non-active beams 295. Non-active beams 295 are beams that are in an inactive DTX phase at the radio access node. That is, the radio access node operating in DTX mode does not transmit to or receive transmissions from UEs on non-active beams 295. Active serving beams 275 are beams that are actively transmitting to and/or receiving transmissions from UEs at a radio access node. Finally, monitored beams 285 are beams that are monitored by UE(s) but transmissions are not actively scheduled for UEs on those beams. In an embodiment, the radio access node may transmit a reference signal(s) to UEs on monitored beams 285, but the UE does not have an established communication with the radio access node via a monitored beam 285. In an embodiment, monitored beams 285 may become active beams and therefore, monitored beams 285 may be part of a beam set serving UEs.

In a non-limiting embodiment shown in FIG. 5, a radio access node 210 has, for example, five different antenna beams available for communication. Radio access node 210 may communicate with UEs on all of the available antenna beams or a subset of antenna beams. In an embodiment, an antenna of radio access node 210 may provide coverage to a particular area, e.g., a cell or sector, or a smaller coverage area defined by a subset of antenna beams, which may be referred to as an antenna beam set or beam set, interchangeably.

According to existing approaches, a radio access node is not able to coordinate transmissions according to beam set, or collectively. Rather, radio access node transmits to each UE on a per UE basis. For example, for a UE operating in DRX mode and associated with a particular beam set, radio access node will activate the beam set according to the UE's specific DRX cycle in order to schedule and/or page the UE. However, another UE may be associated with the same beam set but have a different DRX cycle or phase. That is, the UE will wake up at a different time than the first UE. Therefore, a radio access node will activate the same beam set once for the first UE and yet again for the second UE according to each UE's DRX phase. Depending on the number of UEs communicating with the radio access node and with differing DRX phases, this is a very inefficient use of resources to continuously activate/deactivate the same beam set.

FIG. 5 illustrates grouping UEs associated with a same beam set and further assigning the same DRX cycle to each UE in the group. By assigning the same DRX cycle to all UEs in a group, the UEs will wake up in groups 220, 240, 260, at the same active time occasions according to the DRX cycle assigned to the group. For example, radio access node 210 communicates with UEs in group 220 via a particular beam set 230 comprised of two active beams during the active time corresponding to the DRX phase of group 220. At a different time, radio access node 210 communicates with UEs in group 240 via an antenna beam set 250 comprised of one active beam during the active time corresponding to the DRX cycle of group 240. And yet at another time, radio access node 210 communicates with UEs in group 260 via an antenna beam set 270 comprised of one active beam and two monitored beams during the active time corresponding to the DRX cycle of group 260.

As shown, in an embodiment, radio access node 210 may activate and deactivate beam transmission according to UE groups, which groups have the same DRX phase. Depending on the size of a group of UEs with the same DRX cycle, for example UE group 220, the group may be split into one or more groups with the same DRX cycle, but with a different DRX phase so the active time for each group begins at different times for each separate group. Because the UEs are grouped, a cell or beam set needs to transmit, as a minimum, only when the corresponding UE group has its active time occasions.

While in exemplary embodiment of FIG. 5, the UEs are grouped by beam set, the radio access node 210 may consider further grouping UEs based on other criteria or needs of the UEs. In particular, UEs may be further grouped together because of the commonality in their current location or position, movement, resources used or required, quality of service required, or radio access technology used. When UEs in a same beam set further operate according to a same or similar criteria, it may be advantageous for a radio access node to treat those UEs similarly by grouping the UEs based on those characteristics. For example, UEs moving at a higher speed may require more signaling with the radio access node, while stationary UEs or UEs moving at a slower speed, may require less signaling. Therefore, it may be advantageous for a radio access node to group the UEs accordingly so it can more efficiently manage UEs having differing signaling needs. There are various other circumstances which may cause UEs to act or behave differently with the radio access node where it would be beneficial to further group the UEs according to those characteristics and/or activity. In some exemplary embodiments, UEs in the same beam set may be further grouped together according to any one or more of the following: UEs associated with a same active/monitored set of beams; UEs moving at high speed requiring wider beams; UEs requiring narrower beams; UEs using the same WiFi access point; high-speed UEs using cells/beams that move with the UEs, which may avoid the overhead of handover; UEs performing frequent measurement reporting, for example, due to mobility (in an example, UEs may be grouped or spread out in time based on signalling load at the radio access node; UEs using a same radio access technology, or a same set of frequencies or cell/beams for carrier aggregation or dual connectivity; UEs requiring longer beam transmission times; UEs requiring longer DRX active times; UEs that perform tracking area registration at the same time; a number of UEs using the Intra-Radio Access Technology (RAT) and Inter-RAT access points; a number of UEs using the core network instance or slice; a number of UEs with the same quality of service demands; or a number of UEs providing positioning information.

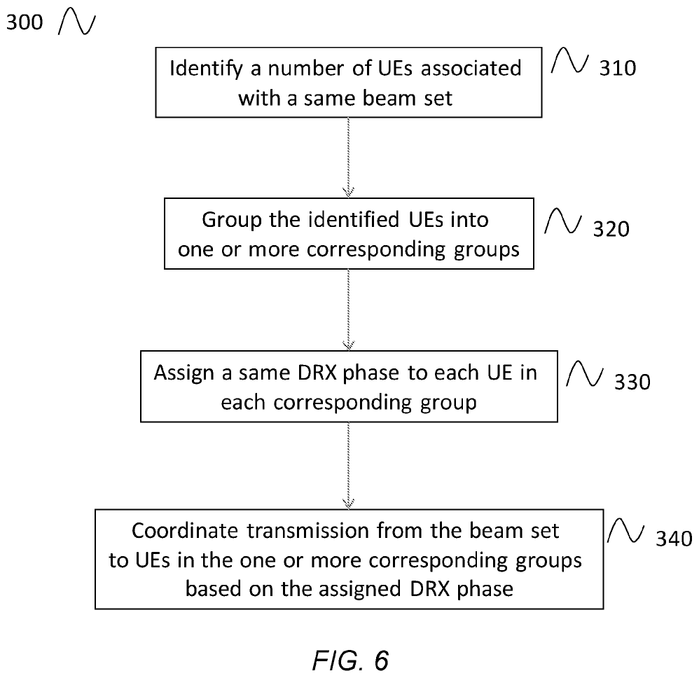

FIG. 6 is an exemplary method 300 performed by a radio access node to group UEs. In 310, a radio access node 210 identifies a number of UEs associated with a same beam set. Next, at 320, the radio access node 210 groups the identified UEs into one or more corresponding groups. For example, depending on the number of UEs identified which may be grouped together (which represents the default group size), capacity of the radio access network, and other criteria, the radio access node may split the identified UEs into multiple groups. At 330, the radio access node assigns a same DRX phase to each UE in each corresponding group. In an exemplary embodiment, the UE groups are assigned the same DRX cycle but each UE group has a different DRX phase so not all UEs in all groups wake up at the same time. Thus, all UEs in a first group will be assigned a first DRX phase, all UEs in a second group will be assigned a second DRX phase, etc. Then, at 340, a radio access node coordinates transmission from the cell/beam set to UEs in the one or more corresponding groups based on the assigned DRX phase.

In an embodiment, when the radio access node coordinates transmissions from the beam set based on the assigned DRX phase, the radio access node handles transmissions to/from the UEs in the group coinciding with the active time of the DRX phase of the UEs in the group. The types of transmission that may occur may include, for example, transmitting reference signals, paging requests, downlink (DL) scheduling information, and/or uplink (UL) scheduling grant information. The radio access node may further transmit using discontinuous reception (DTX). Thus, the radio access node is able to handle transmissions to/from multiple UEs associated with the same beam set to coincide with the same DRX phase, which advantageously provides for efficient use of the radio access node's resources.

A radio access node may perform the above method periodically in order to update the UE groups, as necessary, for example, due to mobility of UEs, changes in a UE's active beam set, etc. Thus, the radio access node advantageously efficiently uses the resources for communicating with groups of UEs with similar needs, and in particular, UEs associated with a same beam set, rather than on a per UE basis.

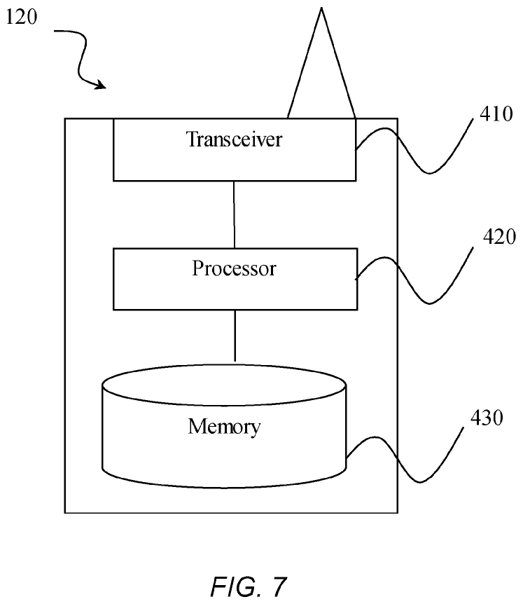

FIG. 7 is an example of a network device 120 suitably operative in accordance with certain embodiments. Examples of the network node include an access point, a radio access point, a base station, a base station controller, an eNodeB (eNB), or other device that can provide wireless communication or transmit CSI-RS within a cell/sector. A network node interface may comprise any entity capable of at least receiving or transmitting radio signals within a radio network and/or cell/sector, or both. The network node comprises transceiver 410, processor 420, and memory 430. In some embodiments, transceiver 410 facilitates transmitting wireless signals to and receiving wireless signals from a user equipment (UE) 110 (e.g., via an antenna), processor 420 executes instructions to provide some or all of the functionality described above as being provided by wireless devices, and memory 430 stores the instructions executed by processor 420.

Processor 420 may comprise any suitable combination of hardware and software implemented in one or more modules to execute instructions and manipulate data to perform some or all of the described functions of the network node. In some embodiments, processor 420 may include, for example, one or more computers, one or more central processing units (CPUs), one or more microprocessors, one or more applications, processing circuitry, and/or other logic.

Memory 430 is generally operable to store instructions, such as a computer program, software, an application comprising one or more of logic, rules, algorithms, code, tables, etc. and/or other instructions capable of being executed by a processor. Examples of memory 930 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Alternative embodiments of the network node may include additional components beyond those shown in FIG. 7 that may be responsible for providing certain aspects of the network node's functionality, including any of the functionality described herein and/or any additional functionality (including any functionality necessary to support the solution described herein).

Particular embodiments of the present disclosure may have one or more advantages. For example, in some embodiments, grouping the UEs according to the one or more criteria, e.g. cell/beam set or other mobility considerations described herein, allows a radio access node 210 to optimize activating and deactivating a cell/beam operating in DTX mode, for a group of UEs rather than on per UE basis. A further advantage is optimization of a UE's DRX phase. For example, UE grouping by DRX phase provides that advantage that the radio access node may transmit reference signals, e.g. CRS and BRS, as seldom as possible because they may be transmitted to a group of UEs simultaneously. Another advantage of UE grouping is that it allows UEs to use efficient DRX when moving at high speed between cells/beams. A further advantage is that grouping allows high speed UEs to get better support when needing wide beams and/or larger active sets. Yet another advantage of UE grouping is that the radio access node may move beams on a group basis, e.g. a group of UEs having the same active time occasions. Certain embodiments may have all, some, or none of these advantages. Other advantages may be apparent to one of ordinary skill in the art.

Since it may be implementation dependent whether the UE would be able to perform, or benefit from, the behaviors described above. The UE may therefore indicate to the network if it supports the behaviors described herein. The eNB can then consider this when determining whether to configure these behaviors for the UE.

Some embodiments herein relate to a method and radio access node for controlling beam transmissions, and in particular, beam transmissions to UEs grouped together based on certain criteria as well as controlling DRX active time.

According to some aspects, this disclosure describes a radio access node (e.g., eNode B) and method for controlling beam transmission by grouping of User Equipment (UEs). Advantageous embodiments of the radio access node (e.g., eNode B) and related method are further described in this disclosure.

In a first aspect, the present disclosure provides a method of controlling beam transmission from a radio access node. The method comprises identifying a number of user equipment (UEs) associated with a same beam set, grouping the identified UEs into one or more corresponding groups, assigning a same discontinuous reception (DRX) phase to the UEs in each corresponding group, and coordinating transmission from the beam set to UEs in the one or more corresponding groups based on the assigned DRX phase. In another embodiment, coordinating transmission from the beam set based on the assigned DRX phase comprises transmitting to the UEs in the group coinciding with the active time of the DRX phase. In another embodiment, the transmission comprises reference signals, paging, downlink (DL) scheduling information, and or uplink (UL) scheduling grant information. In another embodiment, identifying a number of UEs associated with the same beam set comprises identifying: a number of UEs associated with a same active/monitored set of beams, moving at high speed requiring wider beams, a number of UEs requiring narrower beams, a number of UEs using a same WiFi access point, a number of high-speed UEs using cells/beams that move with the UEs, a number of UEs that perform frequent measurement reporting, a number of UEs using a same radio access technology, or a same set of frequencies and/or cell/beams for carrier aggregation or dual connectivity, a number of UEs requiring longer beam transmission times, a number of UEs requiring longer DRX active times, or a number of UEs that perform tracking area registration at the same time. In yet another embodiment, the radio access node transmits using Discontinuous Transmission (DTX).

In a second aspect, a radio access node for controlling beam transmission comprises a processor and a memory. The processor is configured to execute instructions in the memory which cause the radio access node to identify a number of user equipment's (UEs) associated with a same beam set, group the identified UEs into one or more corresponding groups, assign a same discontinuous reception (DRX) phase to the UEs in each corresponding group, and coordinate transmission from the beam set to UEs in the one or more corresponding groups based on the assigned DRX phase. In another embodiment, the processor is further configured to coordinate transmission from the beam set based on the assigned DRX phase by transmitting to the UEs in the group coinciding with the active time of the DRX phase. In another embodiment, the transmission comprises reference signals, paging, downlink (DL) scheduling information, and/or uplink (UL) scheduling grant information. In another embodiment, the processor is further configured to identify a number of UEs associated with the same beam set by identifying: a number of UEs associated with a same active/monitored set of beams, moving at high speed requiring wider beams, a number of UEs requiring narrower beams, a number of UEs using a same WiFi access point, a number of high-speed UEs using cells/beams that move with the UEs, a number of UEs that perform frequent measurement reporting, a number of UEs using a same radio access technology, or a same set of frequencies and/or cell/beams for carrier aggregation or dual connectivity, a number of UEs requiring longer beam transmission times, a number of UEs requiring longer DRX active times, or a number of UEs that perform tracking area registration at the same time. In yet another embodiment, the radio access node transmits using Discontinuous Transmission (DTX).

In a third aspect of the disclosure, a system for controlling beam transmission comprises a radio access node and one or more user equipment (UEs). The radio access node is configured to identify a number of UEs associated with a same beam set from the one or more UEs, group the identified UEs into one or more corresponding groups, assign a same discontinuous reception (DRX) phase to the UEs in each corresponding group, and coordinate transmission from the beam set to UEs in the one or more corresponding groups based on the assigned DRX phase. In another embodiment, the radio access node is further configured to coordinate transmission from the beam set based on the assigned DRX phase by transmitting to the UEs in the group coinciding with the active time of the DRX phase. In another embodiment, the transmission comprises reference signals, paging, downlink (DL) scheduling information, and/or uplink (UL) scheduling grant information. In another embodiment, radio access node is further configured to identify a number of UEs associated with the same beam set by identifying: a number of UEs associated with a same active/monitored set of beams, a number of UEs moving at high speed requiring wider beams, a number of UEs requiring narrower beams, a number of UEs using a same WiFi access point, a number of high-speed UEs using cells/beams that move with the UEs, a number of UEs that perform frequent measurement reporting, a number of UEs using a same radio access technology, or a same set of frequencies and/or cell/beams for carrier aggregation or dual connectivity, a number of UEs requiring longer beam transmission times, a number of UEs requiring longer DRX active times, or a number of UEs that perform tracking area registration at the same time. In yet another embodiment, the radio access node transmits using Discontinuous Transmission (DTX).

In a fourth aspect of the disclosure, a non-transitory computer-readable medium comprises instructions which when executed by a processor, cause a radio access node to identify a number of user equipment (UEs) associated with a same beam set, group the identified UEs into one or more corresponding groups, assign a same discontinuous reception (DRX) phase to the UEs in each corresponding group, and coordinate transmission from the beam set to UEs in the one or more corresponding groups based on the assigned DRX phase.

Additional aspects are provided for a computer program and a computer program product for performing the above methods, as will be set forth, in part, in the detailed description, figures and any claims which follow, and in part will be derived from the detailed description. It is to be understood that both the foregoing general description and the following detailed description are exemplary and explanatory only and are not restrictive of the invention as disclosed.

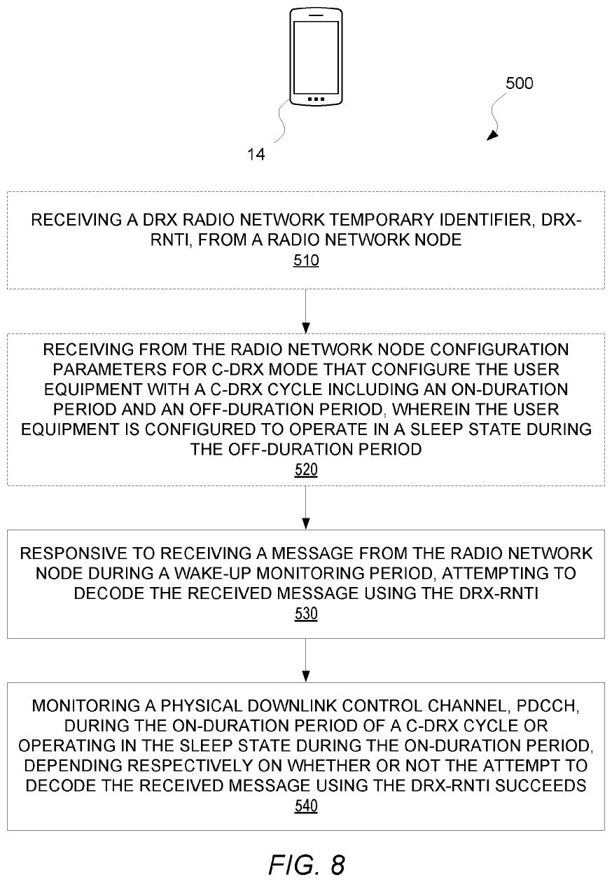

FIG. 8 illustrates additional aspects herein in the form of a method performed by a user equipment 14 for operating in a connected discontinuous reception, C-DRX, mode within which the user equipment 14 has a radio resource control, RRC, connection. The method 500 as shown may include receiving a DRX radio network temporary identifier, DRX-RNTI, 22 from a radio network node 12 (Block 510). The method 500 may also include receiving from the radio network node 12 configuration parameters for C-DRX mode that configure the user equipment 14 with a C-DRX cycle 16 including an on-duration period and an off-duration period (Block 520). The user equipment 14 may be configured to operate in a sleep state during the off-duration period. The method 500 as shown also includes, responsive to receiving a message 26 (e.g., a DCI message received on a PDCCH) from the radio network node 12 during a wake-up monitoring period 24, attempting to decode the received message 26 using the DRX-RNTI 22 (Block 530). Such attempt may include for instance using the DRX-RNTI 22 to check a CRC included in the message 26. Regardless, the method 500 further includes monitoring a control channel 18 (e.g., a Physical Downlink Control Channel, PDCCH) during the on-duration period of a C-DRX cycle or operating in the sleep state during the on-duration period, depending respectively on whether or not the attempt to decode the received message 26 using the DRX-RNTI 22 succeeds (Block 540).

In some embodiments, for example, such monitoring or operating comprises monitoring a control channel 18 (e.g., PDCCH) during the on-duration period of a next C-DRX cycle occurring after the C-DRX cycle within which was received a message 26 during a wake-up monitoring period 24, or operating in the sleep state during the on-duration period of the next C-DRX cycle, depending respectively on whether or not the attempt to decode the received message 26 using the DRX-RNTI 22 succeeds.

In some embodiments, the wake-up monitoring period 24 starts at the beginning of a C-DRX cycle with which the user equipment 14 is configured. Alternatively or additionally, the wake-up monitoring period 24 is shorter than, the on-duration period of a C-DRX cycle.

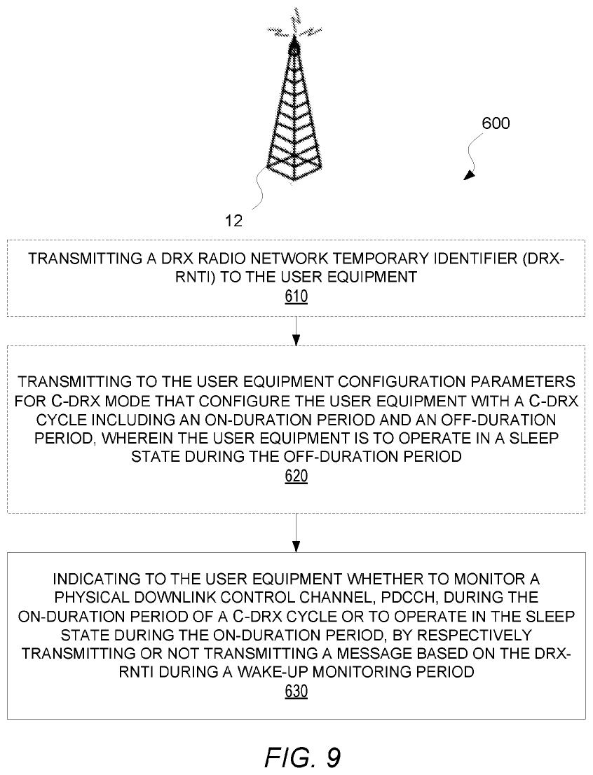

FIG. 9 illustrates further aspects herein in the form of a method 600 performed by a radio network node 12 for controlling DRX active time of a user equipment 14 operating in a connected discontinuous reception, C-DRX, mode within which the user equipment 14 has a radio resource control, RRC, connection. The method 600 as shown may include transmitting a DRX radio network temporary identifier (DRX-RNTI) 22 to the user equipment 14 (Block 610). The method 600 in some embodiments alternatively or additionally includes transmitting to the user equipment 14 configuration parameters for C-DRX mode that configure the user equipment 14 with a C-DRX cycle 16 including an on-duration period and an off-duration period (Block 620). The user equipment 14 is to operate in a sleep state during the off-duration period. The method 600 as shown further includes indicating to the user equipment 14 whether to monitor a control channel 18 (e.g., a Physical Downlink Control Channel, PDCCH) during the on-duration period of a C-DRX cycle 14 or to operate in the sleep state during the on-duration period, by respectively transmitting or not transmitting a message 26 (e.g., a DCI message on a PDCCH) based on the DRX-RNTI 22 during a wake-up monitoring period 24 (Block 630). In some embodiments, for instance, the a CRC included in the message 26 is calculated using the DRX-RNTI 22.

In some embodiments, for example, such indicating comprises indicating to the user equipment 14 whether to monitor a control channel 18 (e.g., a PDCCH) during the on-duration period of the next C-DRX cycle occurring after the C-DRX cycle within which is transmitted a message 26 during a wake-up monitoring period 24, or operating in the sleep state during the on-duration period of the next C-DRX cycle, by respectively transmitting or not transmitting a message 26 based on the DRX-RNTI 22 during the wake-up monitoring period 24.

Note that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

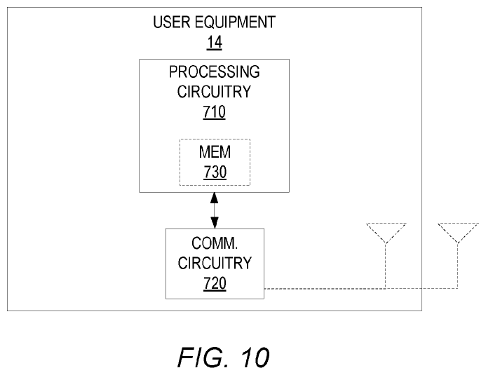

FIG. 10 for example illustrates a user equipment 14 as implemented in accordance with one or more embodiments. As shown, the user equipment 14 includes processing circuitry 710 and communication circuitry 720. The communication circuitry 720 (e.g., radio circuitry) is configured to transmit and/or receive information to and/or from one or more other nodes, e.g., via any communication technology. Such communication may occur via one or more antennas that are either internal or external to the user equipment 14. The processing circuitry 710 is configured to perform processing described above, such as by executing instructions stored in memory 730. The processing circuitry 710 in this regard may implement certain functional means, units, or modules.

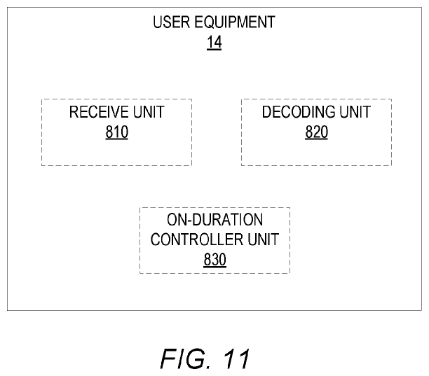

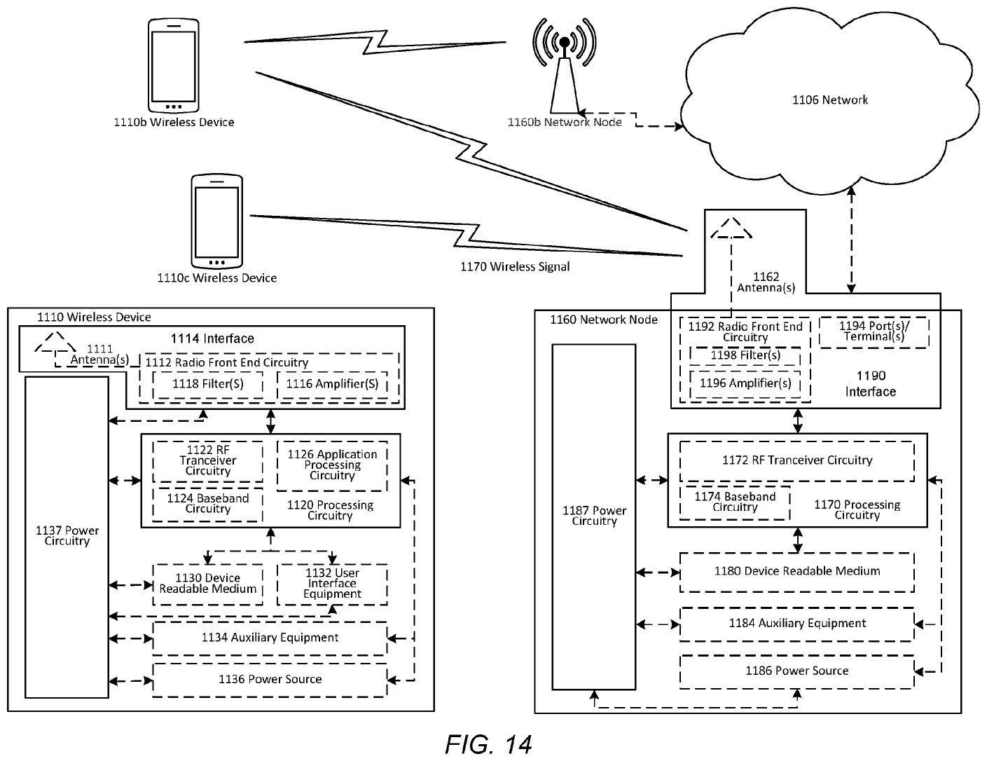

FIG. 11 illustrates a schematic block diagram of a user equipment 14 in a wireless network according to still other embodiments (for example, the wireless network shown in FIG. 14). As shown, the user equipment 14 implements various functional means, units, or modules, e.g., via the processing circuitry 710 in FIG. 10 and/or via software code. These functional means, units, or modules, e.g., for implementing the method(s) herein, include for instance a receiver unit or module 810 for receiving a DRX radio network temporary identifier, DRX-RNTI, 22 from a radio network node 12 and/or for receiving from the radio network node 12 configuration parameters for C-DRX mode that configure the user equipment 14 with a C-DRX cycle 16 including an on-duration period and an off-duration period. Also included may be a decoding unit or module 820 for, responsive to receiving a message 26 (e.g., a DCI message received on a PDCCH) from the radio network node 12 during a wake-up monitoring period 24, attempting to decode the received message 26 using the DRX-RNTI 22. Further included may be an on-duration controller unit or module 830 for monitoring a control channel 18 (e.g., a Physical Downlink Control Channel, PDCCH) during the on-duration period of a C-DRX cycle or operating in the sleep state during the on-duration period, depending respectively on whether or not the attempt to decode the received message 26 using the DRX-RNTI 22 succeeds.

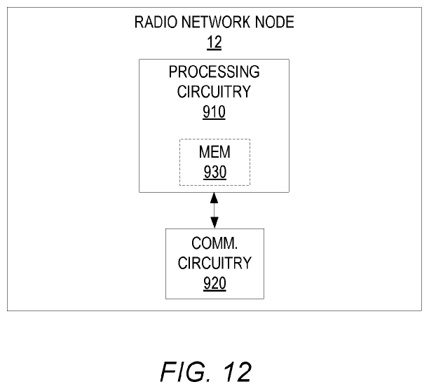

FIG. 12 illustrates a radio network node 12 as implemented in accordance with one or more embodiments. As shown, the radio network node 12 includes processing circuitry 910 and communication circuitry 920. The communication circuitry 920 is configured to transmit and/or receive information to and/or from one or more other nodes, e.g., via any communication technology. The processing circuitry 910 is configured to perform processing described above, such as by executing instructions stored in memory 930. The processing circuitry 910 in this regard may implement certain functional means, units, or modules.

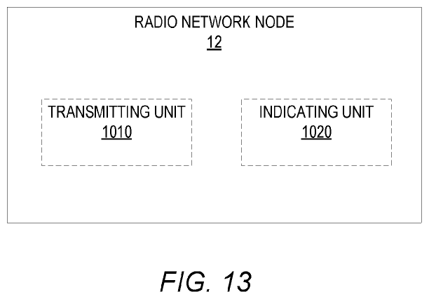

FIG. 13 illustrates a schematic block diagram of a radio network node 12 in a wireless network according to still other embodiments (for example, the radio network node 12 shown in FIG. 14). As shown, the radio network node 12 implements various functional means, units, or modules, e.g., via the processing circuitry 810 in FIG. 12 and/or via software code. These functional means, units, or modules, e.g., for implementing the method(s) herein, include for instance a transmitting unit or module 1010 for transmitting a DRX radio network temporary identifier (DRX-RNTI) 22 to the user equipment 14 and/or for transmitting to the user equipment 14 configuration parameters for C-DRX mode that configure the user equipment 14 with a C-DRX cycle 16 including an on-duration period and an off-duration period. Also included may be an indicating unit or module 1020 for indicating to the user equipment 14 whether to monitor a control channel 18 (e.g., a Physical Downlink Control Channel, PDCCH) during the on-duration period of a C-DRX cycle 14 or to operate in the sleep state during the on-duration period, by respectively transmitting or not transmitting a message 26 (e.g., a DCI message on a PDCCH) based on the DRX-RNTI 22 during a wake-up monitoring period 24.

Those skilled in the art will also appreciate that embodiments herein further include corresponding computer programs.

A computer program comprises instructions which, when executed on at least one processor of a user equipment 14 or radio network node 12, cause the user equipment 14 or radio network node 12 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of a user equipment 14 or radio network node 12, cause the user equipment 14 or radio network node 12 to perform as described above.

Embodiments further include a computer program product comprising program code portions for performing the steps of any of the embodiments herein when the computer program product is executed by a computing device. This computer program product may be stored on a computer readable recording medium.

Although the subject matter described herein may be implemented in any appropriate type of system using any suitable components, the embodiments described herein relate to a wireless network, such as the example wireless communication network illustrated in FIG. 14. For simplicity, the wireless communication network of FIG. 14 only depicts network 1106, network nodes 1160 and 1160b, and WDs 1110, 1110b, and 1110c. The wireless communication network may further include any additional elements suitable to support communication between wireless devices or between a wireless device and another communication device, such as a landline telephone. Of the illustrated components, network node 1160 and wireless device (WD) 1110 are depicted with additional detail. The illustrated wireless communication network may provide communication and other types of services to one or more wireless devices to facilitate the wireless devices' access to and/or use of the services provided by the wireless communication network.

The wireless communication network may comprise and/or interface with any type of communication, telecommunication, data, cellular, and/or radio network or other similar type of system. In some embodiments, the wireless communication network may be configured to operate according to specific standards or other types of predefined rules or procedures. Thus, particular embodiments of the wireless communication network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components may work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless communication network to enable and/or provide wireless access to the wireless device and/or to perform other functions (e.g., administration) in the wireless communication network. Examples of network nodes include, but are not limited to, access points (APs) (e.g., radio access points), base stations (BSs) (e.g., radio base stations, Node Bs, and evolved Node Bs (eNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, network node 1160 may be a virtual network node as described in more detail below. More generally, however, network nodes may represent any suitable device (or group of devices) capable, configured, arranged, and/or operable to enable and/or provide a wireless device with access to the wireless communication network or to provide some service to a wireless device that has accessed the wireless communication network.

In FIG. 14, Network node 1160 includes processing circuitry 1170, device readable medium 1180, interface 1190, user interface equipment 1182, auxiliary equipment 1184, power source 1186, power circuitry 1187, and antenna 1162. Although network node 1160 illustrated in the example wireless communication network of FIG. 14 may represent a device that includes the illustrated combination of hardware components, other embodiments may comprise network nodes with different combinations of components. It is to be understood that a network node may comprise any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features or benefits discussed herein.

In some embodiments, processing circuitry 1170 may include a system on a chip (SOC) and may include one or more of radio frequency (RF) transceiver circuitry 1172, and baseband processing circuitry 1174 in addition to application processing circuitry 1176. In some embodiments, radio frequency (RF) transceiver circuitry 1172, baseband processing circuitry 1174, and application processing circuitry 1176 may be on separate chips (or sets of chips). In alternative embodiments, part or all of baseband processing circuitry 1174 and application processing circuitry 1176 may be combined into one chip or set of chips, and RF transceiver circuitry 1172 may be on a separate chip or set of chips. In still alternative embodiments, part or all of RF transceiver circuitry 1172 and baseband processing circuitry 1174 may be on the same chip or set of chips, and application processing circuitry 1176 may be on a separate chip or set of chips. In yet other alternative embodiments, part or all of RF transceiver circuitry 1172, baseband processing circuitry 1174, and application processing circuitry 1176 may be combined in the same chip or set of chips.

In certain embodiments, some or all of the functionality described herein as being provided by a network node, base station, eNB or other such network device may be provided by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Processing circuitry 1170 may be configured to perform any determining operations described herein as being performed by a network node. Determining as performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 may be used in the wired or wireless communication of signalling and/or data between network node 1160, network 1106, and/or WDs 1110. Interface 1190 may be transceiver circuitry that comprises one or more ports or terminals 1194 that may perform any formatting, coding, or translating that may be needed to allow network node 1160 to send and receive data, for example to and from network 1106 over a wired connection. Interface 1190 may also include radio front end circuitry 1192 that may be coupled to or a part of antenna 1162. Radio front end circuitry 1192 may be coupled to various filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. In certain alternative embodiments, network node 1160 may not include separate radio front end circuitry 1192, instead, processing circuitry 1170 may comprise radio front end circuitry and may be connected to antenna 1162 without separate radio front end circuitry 1192. Radio front end circuitry 1192 may receive digital data that is to be sent out to other network nodes or WDs via a wireless connection. The radio may convert the digital data into a radio signal having the appropriate channel and bandwidth parameters using a combination of filters 1198 and/or amplifiers 1196. The radio signal may then be transmitted via antenna 1162 to the appropriate recipient (e.g., WD 1110). These, or similar, components may also work for wireless signals that are received by antenna 1162 and converted into digital data for use by processing circuitry 1170.

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and may be configured to supply the components network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

User interface equipment 1182 may include input interfaces, devices and circuits, and output interfaces, devices and circuits. User interface equipment 1182 is configured to allow input of information into network node 1160, and is connected to processing circuitry 1170 to allow processing circuitry 1170 to process the input information. User interface equipment 1182 may include, for example, a microphone, a proximity or other sensor, keys/buttons, a touch display, one or more cameras, a USB port, or other input elements. User interface equipment 1182 is also configured to allow output of information from network node 1160, and to allow processing circuitry 1170 to output information from network node 1160. User interface equipment 1182 may include, for example, a speaker, a display, vibration generating circuitry, a USB port, a headphone interface, or other output elements. Using one or more input and output interfaces of user interface equipment 1182, network node 1160 may communicate with end users and/or the wireless network, and allow them to benefit from the functionality described herein. For example, user interface equipment 1182 may be used when installing, configuring, troubleshooting, repairing, or otherwise working on network node 1160.

Alternative embodiments of network node 1160 may include additional components beyond those shown in FIG. 14 that may be responsible for providing certain aspects of the network node's functionality, including any of the functionality described herein and/or any functionality necessary to support the subject matter described herein.

As used herein, wireless device (WD) refers to a device capable, configured, arranged and/or operable to communicate wirelessly with network nodes and/or other wireless devices. Communicating wirelessly may involve transmitting and/or receiving wireless signals using electromagnetic signals, radio waves, infrared signals, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, user equipment (UE), smart phone, mobile phone, cell phone, voice over IP (VoIP) phone, wireless local loop phone, desktop computer, personal data assistant (PDA), wireless cameras, gaming terminal devices, music storage, playback appliances, wearable terminal devices, wireless endpoints, mobile stations, tablets, laptops, laptop-embedded equipment (LEE), laptop-mounted equipment (LME), USB dongles, smart devices, wireless customer-premise equipment (CPE) and vehicle-mounted wireless terminal devices. A WD may support device-to-device (D2D) communication, for example by implementing a 3GPP standard for sidelink communication, and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as a machine-type communication (MTC) device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal. Note that UEs may further be referred to as wireless terminals, mobile terminals and/or mobile stations, mobile telephones, cellular telephones, laptops, tablet computers or surf plates with wireless capability. The UEs in the present context may be, for example, portable, pocket-storable, hand-held, computer-comprised, or vehicle-mounted mobile devices, enabled to communicate voice and/or data, via the RAN, with another entity, such as another wireless terminal or a server.

Wireless device 1110 may include antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies integrated into WD 1110, such as, for example, GSM, WCDMA, LTE, NR, WiFi, WiMAX, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

Interface 1114 may be transceiver circuitry comprising various radio front end circuitry 1112, filters 1118 and amplifiers 1116. Interface 1114 is connected to antenna 1111 and processing circuitry 1120, and is configured to condition signals communicated between antenna 1111 and processing circuitry 1120. Radio front end circuitry 1112 may be coupled to or a part of antenna 1111. Radio front end circuitry 1112 may be coupled to various filters 1118 and amplifiers 1116. Radio front end circuitry may be configured to condition signals communicated between antenna 1111 and processing circuitry 1120. In some embodiments, WD 1110 may not include separate radio front end circuitry 1112, rather processing circuitry 1120 may comprise radio front end circuitry and may be connected to antenna 1111. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111 to the appropriate recipient. These, or similar, components may also work for wireless signals that are received by antenna 1111 and converted into digital data for use by processing circuitry 1120.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

Processing circuitry 1120 of WD 1110 may comprise a SOC and may include one or more of RF transceiver circuitry 1122, and baseband processing circuitry 1124, in addition to application processing circuitry 1126. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being provided by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining operations described herein as being performed by a WD. Determining as performed by processing circuitry 1120 may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store instructions, such as a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a remotely hosted website or application. User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input elements. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output elements. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet) or photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

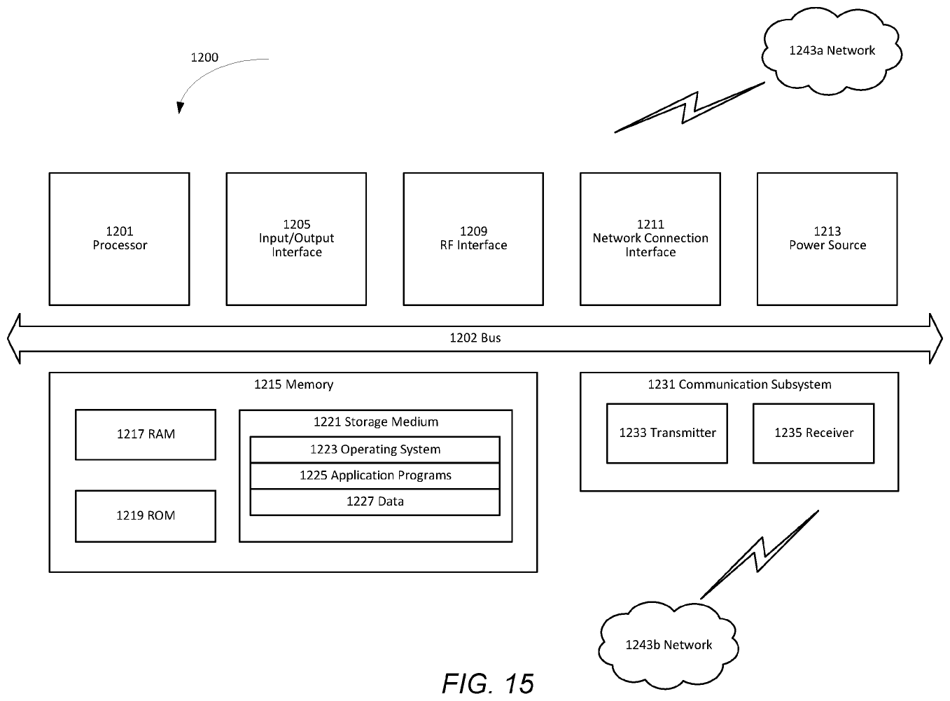

FIG. 15 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user. UE 1200, as illustrated in FIG. 15, is one example of a WD configured for communication in accordance with one or more communication standards promulgated by the 3^{rd} Generation Partnership Project (3GPP), such as 3GPP's GSM, UMTS, LTE, and/or 5G standards.

In FIG. 15, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 may include operating system 1223, application program 1225, data 1227, or the like. Specific devices may utilize all of the components shown in FIG. 15, or only a subset of the components. The level of integration between the components may vary from device to device. Further, specific devices may contain multiple instances of a component, such as multiple processors, memories, transceivers, transmitters, receivers, etc.

In FIG. 15, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a mouse, a trackball, a directional pad, a trackpad, a presence-sensitive input device, a display such as a presence-sensitive display, a scroll wheel, a camera (e.g., a digital camera, a digital video camera, a web camera, etc.), a microphone, a sensor, a smartcard, and the like. The presence-sensitive input device may include a digital camera, a capacitive or resistive touch sensor, a digital video camera, a web camera, a microphone, a sensor, or the like to sense input from a user. The presence-sensitive input device may be combined with the display to form a presence-sensitive display. Further, the presence-sensitive input device may be coupled to processing circuitry 1201. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 15, RF interface 1209 may be configured to provide a communication interface to RF components such as a transmitter, a receiver, and an antenna. Network connection interface 1211 may be configured to provide a communication interface to network 1243a. Network 1243a may encompass wired and wireless communication networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other nodes over a communication network according to one or more communication protocols known in the art or that may be developed, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 15, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols known in the art or that may be developed, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and wireless communication networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 performs the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

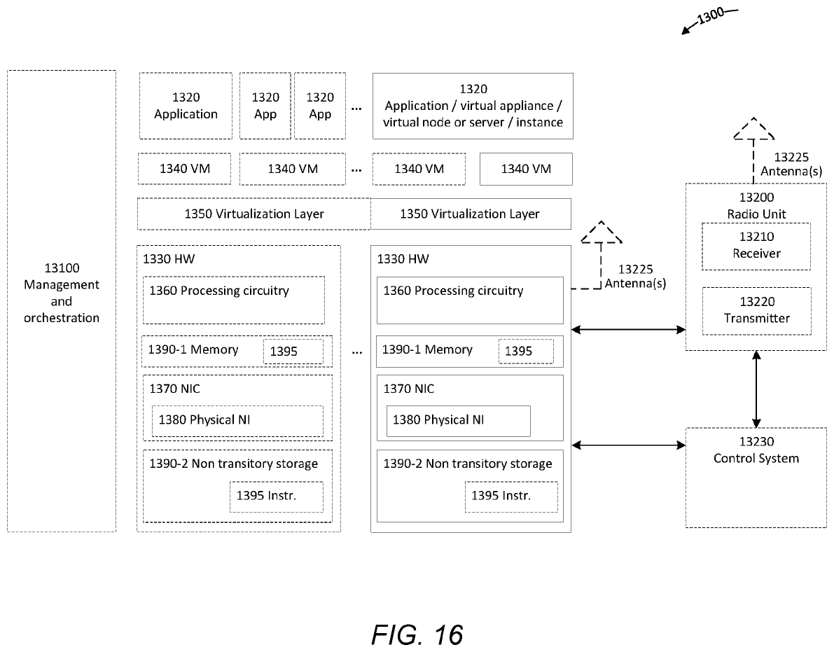

FIG. 16 is a schematic block diagram illustrating a virtualization environment 1300 in which functions implemented by some embodiments may be virtualized. In the present context, virtualizing means creating virtual versions of apparatus or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 run in virtualization environment 1300 which provides hardware 1330 comprising processing circuitry 1360 and memory 1390. Memory 1390 contains instructions 1395 executable by processing circuitry 1360 whereby application 1320 is operative to provide any of the relevant features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware devices may also include non-transitory, persistent, machine-readable storage media 1390-2 having stored therein software 1395 and/or instruction executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 16, hardware 1330 may be a standalone network node, with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a virtual machine 1340 is a software implementation of a physical machine that runs programs as if they were executing on a physical, non-virtualized machine. Each of virtual machines 1340, and that part of the hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 16.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

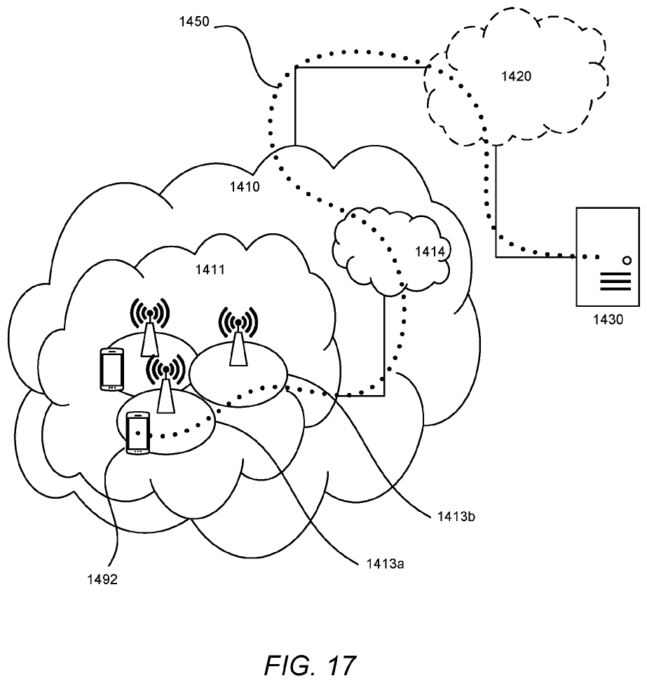

Although the solutions described above may be implemented in any appropriate type of system using any suitable components, particular embodiments of the described solutions may be implemented in a network configuration such as the example communication network illustrated in FIG. 17.

In the example embodiment disclosed above a connection is established between a host computer 1430, such as a server or a media server, and a wireless device 1492, as is shown by the connection arrow 1450, through and by a private/hosted network 1420, a Core Network (CN) 1414 and a cellular wireless access network 1411 comprising several Wide Area Access (WAN) cells 1413a, 1413b, 1413c. The CN 1414 and the access network 1411 are indicated to belong to a telecommunication network 1410 and to be 3GPP compliant networks, however it should be noted that it is possible to establish connectivity between the host computer 1430 and the wireless device 1492 using non-3GPP wireless networks such as for instance a WiFi network. In some embodiments the host computer 1430 is configured to provide the wireless device 1492 with data over the established connection 1450. In other embodiments the wireless device 1492 provides the host computer 1430 with data and in yet other embodiments the wireless device 1492 and the host computer 1430 provide each other with data.

The data may be both user plane data and control plane data. Control plane data can be used by the wireless device 1492 and host computer 1430 for configuration, and user plane data are providing information from and to respective part. Example of user plane data can for instance be voice, video or other type of data primarily used for consumption on either end.

The communication system illustrated above is suitable for providing data transport between a service provider and a wireless device 1492, such as a User Equipment (UE), an Internet of Things (IoT) device and several other types of devices utilizing the wireless connectivity provided in part by the wireless network and in part of the CN, privet/hosted network and host computer.

The communication system provides a number of required and optional features for delivering secure, fast and flexible data transport such as Mobility, Authentication, Charging, Low Latency, High Availability and many other.

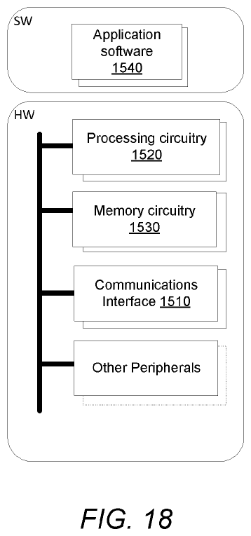

Although the solutions described above may be implemented in any appropriate type of system using any suitable components, particular embodiments of the described solutions may be at least partly implemented in a host computer illustrated in FIG. 18.

As shown in FIG. 18, the host computer is provided with a communications interface 1510 for sending and receiving data to and from the wireless device. The communications interface 1510 comprises in one embodiment at least one, but in some embodiment multiple receiver circuitry, transmitting circuitry and processing circuitry for controlling the communication interface 1510. Thus the term communications interface 1510 should be construed to include embodiments where communications is facilitated in wireless mode, in wired mode or in both wireless and wired mode. A communication interface 1510 may consequently comprise features supporting multiple simultaneous communication channels. The host computer is further provided with processing circuitry 1520 coupled to memory circuitry 1530 and the said transmitter and receiver circuitry for controlling the host computer and executing software applications running on the host computer, such as software application implementing at least parts of the solutions disclosed herein.

The host computer may also be fitted with other circuitry for performing various services, functions and processing as needed to fulfil and comply with the features required for providing the requested services. The application software 1540 is running on the processing circuitry 1520, controlling the memory circuitry 1530 and communications interface 1510 and will generate and send data to the wireless device as well as receive, analyse, store and consume data from the wireless device. In one embodiment the software application 1540 may be hosted in a cloud environment and will then share hardware with other software applications possibly from other enterprises.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein are described with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

1.-37. (canceled)

38. A user equipment configured to operate in a connected discontinuous reception, C-DRX, mode within which the user equipment has a radio resource control, RRC, connection, the user equipment comprising radio circuitry and processing circuitry wherein the user equipment is configured to:
receive a DRX radio network temporary identifier, DRX-RNTI, from a radio network node;
receive from the radio network node configuration parameters for C-DRX mode that configure the user equipment with a C-DRX cycle including an on-duration period and an off-duration period, wherein the user equipment is configured to operate in a sleep state during the off-duration period;
responsive to receiving a message from the radio network node during a wake-up monitoring period, attempt to decode the received message using the DRX-RNTI; and
monitor a Physical Downlink Control Channel, PDCCH, during the on-duration period of a C-DRX cycle or operate in the sleep state during the on-duration period, depending respectively on whether or not the attempt to decode the received message using the DRX-RNTI succeeds.

39. The user equipment of claim 38, wherein the DRX-RNTI is assigned to a group of user equipments that includes the user equipment.

40. The user equipment of claim 39, wherein the user equipments in the group are assigned the same C-DRX phase within the C-DRX cycle, wherein the C-DRX phase is the on-duration period of the C-DRX cycle.

41. The user equipment of claim 39, wherein the user equipments in the group are associated with the same active or monitored set of beams.

42. The user equipment of claim 39, wherein the received message specifies which user equipments in the group are to monitor a PDCCH during the on-duration period of the C-DRX cycle.

43. The user equipment of claim 38, further configured to, during the wake-up monitoring period, only monitor a common search space that is common to multiple user equipments.

44. The user equipment of claim 38, wherein the configuration parameters specify when the wake-up monitoring period occurs.

45. The user equipment of claim 38, wherein the configuration parameters specify whether or not the user equipment is to prepare to transmit in the on-duration period of a C-DRX cycle, and/or whether or not the user equipment is to prepare to transmit in the wake-up monitoring period.

46. The user equipment of claim 38, wherein the wake-up monitoring period starts at the beginning of a C-DRX cycle with which the user equipment is configured.

47. The user equipment of claim 38, wherein the wake-up monitoring period is shorter than, the on-duration period of a C-DRX cycle.

48. The user equipment of claim 38, configured to monitor a PDCCH during the on-duration period of a next C-DRX cycle occurring after the C-DRX cycle within which was received a message during a wake-up monitoring period, or operate in the sleep state during the on-duration period of the next C-DRX cycle, depending respectively on whether or not the attempt to decode the received message using the DRX-RNTI succeeds.

49. The user equipment of claim 38, wherein the message is a downlink control information, DCI, message received on a PDCCH, and wherein the user equipment is configured to attempt to decode the message by using the DRX-RNTI to check a cyclic redundancy code, CRC, included in the DCI message.

50. A method performed by a user equipment for operating in a connected discontinuous reception, C-DRX, mode within which the user equipment has a radio resource control, RRC, connection, the method comprising:
receiving a DRX radio network temporary identifier, DRX-RNTI, from a radio network node;
receiving from the radio network node configuration parameters for C-DRX mode that configure the user equipment with a C-DRX cycle including an on-duration period and an off-duration period, wherein the user equipment is configured to operate in a sleep state during the off-duration period;
responsive to receiving a message from the radio network node during a wake-up monitoring period, attempting to decode the received message using the DRX-RNTI; and
monitoring a Physical Downlink Control Channel, PDCCH, during the on-duration period of a C-DRX cycle or operating in the sleep state during the on-duration period, depending respectively on whether or not the attempt to decode the received message using the DRX-RNTI succeeds.

51. The method of claim 50, wherein the DRX-RNTI is assigned to a group of user equipments that includes the user equipment, and wherein one or more of:
the user equipments in the group are assigned the same C-DRX phase within the C-DRX cycle, wherein the C-DRX phase is the on-duration period of the C-DRX cycle; and
the user equipments in the group are associated with the same active or monitored set of beams.

52. The method of claim 50, further comprising, during the wake-up monitoring period, only monitoring a common search space that is common to multiple user equipments.

53. The method of claim 50, wherein the configuration parameters specify one or more of:
when the wake-up monitoring period occurs;
whether or not the user equipment is to prepare to transmit in the on-duration period of a C-DRX cycle; and
whether or not the user equipment is to prepare to transmit in the wake-up monitoring period.

54. The method of claim 50, wherein the wake-up monitoring period starts at the beginning of a C-DRX cycle with which the user equipment is configured, and wherein the wake-up monitoring period is shorter than the on-duration period of a C-DRX cycle.

55. The method of claim 50, comprising monitoring a PDCCH during the on-duration period of a next C-DRX cycle occurring after the C-DRX cycle within which was received a message during a wake-up monitoring period, or operating in the sleep state during the on-duration period of the next C-DRX cycle, depending respectively on whether or not the attempt to decode the received message using the DRX-RNTI succeeds.

56. A radio network node for controlling DRX active time of a user equipment operating in a connected discontinuous reception, C-DRX, mode within which the user equipment has a radio resource control, RRC, connection, the radio network node comprising radio circuitry and processing circuitry wherein the radio network node is configured to:
transmit a DRX radio network temporary identifier, DRX-RNTI, to the user equipment;
transmit to the user equipment configuration parameters for C-DRX mode that configure the user equipment with a C-DRX cycle including an on-duration period and an off-duration period, wherein the user equipment is to operate in a sleep state during the off-duration period; and
indicate to the user equipment whether to monitor a Physical Downlink Control Channel, PDCCH, during the on-duration period of a C-DRX cycle or to operate in the sleep state during the on-duration period, by respectively transmitting or not transmitting a message based on the DRX-RNTI during a wake-up monitoring period.

57. The radio network node of claim 56, wherein the DRX-RNTI is assigned to a group of user equipments that includes the user equipment, and wherein one or more of:
the user equipments in the group are assigned the same C-DRX phase within the C-DRX cycle, wherein the C-DRX phase is the on-duration period of the C-DRX cycle; and
the user equipments in the group are associated with the same active or monitored set of beams.

58. The radio network node of claim 56, configured to, during the wake-up monitoring period, transmit control messages only in a common search space that is common to multiple user equipments.

59. The radio network node of claim 56, wherein the configuration parameters specify one or more of:
when the wake-up monitoring period occurs;
whether or not the user equipment is to prepare to transmit in the on-duration period of a C-DRX cycle; and
whether or not the user equipment is to prepare to transmit in the wake-up monitoring period.

60. The radio network node of claim 56, wherein the wake-up monitoring period starts at the beginning of a C-DRX cycle with which the user equipment is configured, and wherein the wake-up monitoring period is shorter than the on-duration period of a C-DRX cycle.

61. The radio network node of claim 56, configured to indicate to the user equipment whether to monitor a PDCCH during the on-duration period of a next C-DRX cycle occurring after the C-DRX cycle within which is transmitted a message during a wake-up monitoring period, or operating in the sleep state during the on-duration period of the next C-DRX cycle, by respectively transmitting or not transmitting a message based on the DRX-RNTI during the wake-up monitoring period.

62. The radio network node of claim 56, wherein the message is a downlink control information, DCI, message transmitted on a PDCCH, and wherein the a cyclic redundancy code, CRC, included in the message is calculated using the DRX-RNTI.

63. A method performed by a radio network node for controlling DRX active time of a user equipment operating in a connected discontinuous reception, C-DRX, mode within which the user equipment has a radio resource control, RRC, connection, the method comprising:
transmitting a DRX radio network temporary identifier, DRX-RNTI, to the user equipment;
transmitting to the user equipment configuration parameters for C-DRX mode that configure the user equipment with a C-DRX cycle including an on-duration period and an off-duration period, wherein the user equipment is to operate in a sleep state during the off-duration period; and
indicating to the user equipment whether to monitor a Physical Downlink Control Channel, PDCCH, during the on-duration period of a C-DRX cycle or to operate in the sleep state during the on-duration period, by respectively transmitting or not transmitting a message based on the DRX-RNTI during a wake-up monitoring period.
